(19) United States
(12) Patent Application Publication
(10) Pub. No.: US 2006/0029097 A1
(43) Pub. Date: Feb. 9, 2006

(54) Dynamic allocation and configuration of a computer system's network resources

(76) Inventors: Michael Sean McGee, Round Rock, TX (US); Mark Richard Enstone, Austin, TX (US); Michael Sean McIntyre, Austin, TX (US); Gregory Thomas Howard, Cedar Park, TX (US); Mark Christopher Stratton, Georgetown, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,524

(22) Filed: Feb. 1, 2005

Related U.S. Application Data
(60) Provisional application No. 60/577,818, filed on Jun. 7, 2004.

(51) Int. Cl. H04J 3/22

(52) U.S. Cl. 370/468

(57) ABSTRACT

A resource allocation application is configured to run on a computer system that is coupled through a plurality of network resources to one or more networks. The resources are initially allocated among one or more teams and a pool. One or more usage policies are established for at least one of the teams. Resource usage is continuously monitored to identify actionable resource usage conditions. The network resources are automatically reconfigured in accordance with the one or more usage policies in response to the actionable resource usage conditions.

This application claims the benefit of U.S. Provisional Application No. 60/577,818, filed Jun. 7, 2004.

### BACKGROUND

Computers and other devices are commonly interconnected to facilitate communication among one another using any one of a number of available standard network architectures and any one of several corresponding and compatible network protocols. One of the most commonly employed of such standard architectures is the Ethernet® network architecture. Other types of network architectures that are less widely used include ARCnet, Token Ring and FDDI. Variations of the Ethernet® standard are differentiated from one another based on characteristics such as maximum throughput (i.e. the highest data transmission rate) of devices coupled to the network, the type of medium used for physically interconnecting the devices (e.g. coaxial cable, twisted pair cable, optical fibers, etc.) and the maximum permissible length of the medium.

The 10Base-T and 100Base-T Ethernet® standards, for example, designate a maximum throughput of 10 and 100 Megabits per second respectively, and are coupled to the network over twisted pair cable. The 1000Base-T (or Gigabit) Ethernet® standard designates a maximum throughput of 1000 Mbps (i.e. a Gigabit per second) over twisted pair cable. Recent advancement in the speed of integrated circuits has facilitated the development of even faster variations of the Ethernet® network architecture, such as one operating at 10 Gigabits per second (10 Gbps) and for which the transmission medium is typically optical fibers. Of course, the greater the throughput, the more expensive the network resources required to sustain that throughput. Ethernet® is a registered trademark of Xerox Corporation.

Packet switched network protocols are commonly employed with architectures such as the Ethernet® standard. These protocols dictate the manner in which data to be transmitted between devices coupled to the network are formatted into packets for transmission. Examples of such protocols include Transmission Control Protocol/Internet Protocol (TCP/IP), the Internet Protocol eXchange (IPX), NetBEUI and the like. NetBEUI is short for NetBIOS Enhanced User Interface, and is an enhanced version of the NetBIOS protocol used by network operating systems such as LAN Manager, LAN Server, Windows® for Workgroups, Windows®95 and Windows NT®. Windows® and Windows NT® are registered trademarks of Microsoft Corporation. NetBEUI was originally designed by IBM for IBM's LAN Manager Server and later extended by Microsoft and Novell. TCP/IP is typically used in Internet applications, or in intranet applications such as a local area network (LAN). The data packets received through a network resource of the destination device are processed in reverse according to the selected protocol to reassemble the payload data contained within the received packets. In this manner, computers and other devices can share information in accordance with these higher level protocols over the common network.

One of the most basic and widely implemented networks is the Local Area Network (LAN). In its simplest form, a LAN is a number of devices (e.g. computers, printers and other specialized peripherals) connected to one another by some form of signal transmission medium such as coaxial cable to facilitate direct peer-to-peer communication there between. A common network paradigm, often employed in LANs as well as other networks, is known as the client/server paradigm. This paradigm involves coupling one or more large computers (typically having very advanced processing and storage capabilities) known as servers to a number of smaller computers (such as desktops or workstations) and other peripheral devices shared by the computers known as clients. The clients send requests over the network to the one or more servers to facilitate centralized information storage and retrieval through programs such as database management and application programs stored on the server(s). Servers may also be used to provide centralized access to other networks and various other services as are known to those of skill in the art. The servers provide responses over the network to the clients in response to their requests. Clients and/or servers can also share access to peripheral resources, such as printers, scanners, and the like over the network.

LANs are sometimes coupled together to form even larger networks, such as wide area networks (WANs), or they may be coupled to the Internet. LANs may also be segmented into logical sub-networks called virtual LANs (VLANs), and a particular network device's access to the segments is controlled by a switch that can be programmed in real time to couple network resources of that device to one, some or all of the VLAN segments.

For a given network architecture such as Ethernet®, various network topologies may be implemented. A network topology simply defines the manner in which the various network devices are physically interconnected. For example, the simplest topology for an Ethernet® LAN is a bus network. A bus network couples all of the devices to the same transmission medium (e.g. cable, optical fiber, etc.). One manner in which this is commonly accomplished is through use of a T-connector and two cables to connect one device to T-connectors coupled to each of its two neighbors on the network. The problem with the bus network approach is that if the interface for one of the devices fails or if one of the devices is removed from the network, the network bus must be reconnected to bypass the missing or malfunctioning device or the network is broken.

A better approach is to use a star topology, where all of the network devices are coupled together through a device such as a concentrator. A concentrator acts to consolidate all of the network connections to a single point, and is able to combine signals received from slower devices to communicate with a device capable of supporting a higher throughput. Thus, requests coming from several clients may be combined and sent to a server if the server has the ability to handle the higher data rate of the combined signals. Each of the network devices is coupled through one connector to the concentrator, and if any one of the devices is removed from the network, the other devices can continue to communicate with one another over the network without interruption.

Another topology that may be used when higher bandwidth is desired is a hub network. A hub network is similar to the bus network described above in that it involves a single connective medium through which a number of devices are interconnected. The difference is that for a hub network, the devices coupled to the single connector are hub devices rather than single network devices. Each hub device can couple a large number of network devices to the single connector. The single connector, called a backbone, can be designed to have a very high bandwidth sufficient to handle the confluence of data from all of the hubs.

Network interface resources are required to couple computers and other devices to a network. These interface resources are sometimes referred to as network adapter cards or network interface cards (NICs), each adapter card or NIC having at least one port through which a physical link is provided between the network transmission medium and the processing resources of the network device. Data is communicated (as packets in the case of packet switched networks) from the processing resources of one network device to the other. The data is transmitted and received through these interface resources and over the media used to physically couple the devices together. Adapter cards or NICs are commercially available that are designed to support one or more variations of standard architectures and known topologies.

Each of the network devices typically includes a bus system through which the processing resources of the network devices may be coupled to the NICs. The bus system is usually coupled to the pins of edge connectors defining sockets for expansion slots. The NICs are coupled to the bus system of the network device by plugging the NIC into the edge connector of the expansion slot. In this way, the processing resources of the network devices are in communication with any NICs or network adapter cards that are plugged into the expansion slots of that network device. As previously mentioned, each NIC or network adapter must be designed in accordance with the standards by which the network architecture and topology are defined to provide appropriate signal levels and impedances (i.e. the physical layer) to the network. This of course includes an appropriate physical connector for interfacing the NIC to the physical transmission medium employed for the network (e.g. coaxial cable, twisted-pair cable, fiber optic cable, etc.).

It is desirable that certain connections (e.g. access by clients to network server(s)) be as reliable as possible. It is also desirable that some network devices (e.g. network server(s)) be able to receive and respond to numerous incoming requests from other devices on the network (such as clients) as quickly as possible. As processing speed continues to increase and memory access time continues to decrease for a network device such as a server, the bottleneck for device throughput becomes pronounced at the interface to the network. While network architectures and associated network adapters are being designed to handle ever-increasing throughput rates, the price for implementing interface resources supporting the highest available throughput is not always cost-effective.

In light of the foregoing, it has become common to improve the reliability and throughput of a network by coupling some or all of the network devices to the network through redundant network resources. These redundant links to the network may be provided as a team by a plurality of single-port NICs, a single NIC having more than one port or a combination thereof Teaming of network interface resources is particularly common for servers, as the demand for throughput and reliability is typically greatest for servers on a network. Resource teams are typically two or more NICs (actually two or more NIC ports) logically coupled in parallel to appear as a single virtual network adapter to the other devices on the network. These resource teams can provide aggregated throughput of data transmitted to and from the network device employing the team and/or fault tolerance (i.e. resource redundancy to increase reliability).

Fault tolerant teams of network resources commonly employ two or more network adapter or NIC ports, one port being “active” and designated as the “primary,” while each of the other members of the team are designated as “secondary” and are placed in a “standby” mode. A NIC or NIC port in standby mode remains largely idle (it is typically only active to the limited extent necessary to respond to system test inquiries to indicate that it is still operational) until activated to replace the primary adapter when it has failed. In this way, interruption of a network connection to a critical server may be avoided notwithstanding the existence of a failed network adapter card or port.

Load-balancing teams of network resources combine one or more additional network adapters or NICs to increase the aggregate throughput of data traffic between the network and the device. In the case of “transmit” load balancing (TLB) teams, throughput is aggregated for data transmitted from the device to the network. The team member designated as primary, however, handles all of the data received by the team. In the case of “switch-assisted” load balancing (SLB) teams, throughput is balanced over all team members for data transmitted to the network as in TLB teams as well as data received by the team from the network. Typically, the received data is balanced with the support of a switch that is capable of performing load balancing of data destined for the team.

Load-balancing teams employ various algorithms by which network traffic through the team is balanced between the two or more network adapter cards, with transmit load-balancing algorithms usually residing in the transmitting network device, and the receive data load-balancing algorithm residing in the switch to which the team is coupled. Load-balancing teams inherently provide fault tolerance, but most commonly at a lower aggregate throughput than the fully functional team. Employing multiple network resources in tandem can enable a server to meet increasing demands for throughput where one NIC or NIC port would have become saturated (i.e. reached its maximum throughput) without meeting all of the demand. This can happen at a server NIC or NIC port, for example, as more client computers are added to a growing network or as processing capability of existing clients is upgraded, leading to an increase in the rate of client requests and responses to and from the server.

The teaming of network resources and their allocation has been heretofore largely implemented statically. Put another way, a user charged with the task of establishing a network has had to configure teams of network resources for each network device, such as a server, in accordance with an initial expectation of the demand for device throughput as well as the initial network configuration. The initial configuration then remains in place unless or until the user, based on experience and observation of the network traffic conditions, observes inefficiencies, bottlenecks or other problems with the current configuration. Typically, the user must then physically reconfigure the resources (i.e. add, replace and/or remove NICs as well as possibly moving the physical connection to the network) in an attempt to use the resources more efficiently or to correct problems in view of those changed conditions.

Network devices may be added to or subtracted from a network on a regular basis. Moreover, demand for throughput on the network may fluctuate as a function of time of day and day of the week, dynamically shifting between network devices. Thus, even if a user tries to alter the static configuration of teamed networks in response to the changing conditions, by the time the resources are physically reconfigured, new inefficiencies in the allocation of the resources for a device may already be appearing. As a result of the static nature of the resource allocation and the difficulty in actually reallocating them, users will rarely undertake such reconfigurations but will instead endeavor to initially configure resources to meet worst-case usage demands and possibly even anticipated increases in demand. While this may minimize the need for reallocation on a regular basis, it can lead to underutilized resources and thus unnecessary expense to the user.

### SUMMARY OF THE INVENTION

An embodiment of a method of the invention dynamically allocates and configures network resources of a computer system. The network resources are initially allocated between one or more teams and a pool. One or more usage policies are established based on a set of extensible rules for at least one of the one or more teams. The resources are monitored for their current status and usage to identify one or more actionable resource usage conditions. The network resources are reallocated and/or reconfigured in response to the identified usage conditions in accordance with the one or more established policies.

### BRIEF DESCRIPTION OF THE DRAWINGS

For a detailed description of embodiments of the invention, reference will now be made to the accompanying drawings in which:

FIG. 1 is a block diagram that illustrates various features of a computer system, including some features by which the computer system is coupled to a network in accordance with an embodiment of the present invention;

FIG. 2A is a block diagram of a network that includes some features used to couple the computer system of FIG. 1 to a network in accordance with an embodiment of the present invention;

FIG. 2B illustrates a block diagram of a network that includes some features used to couple the computer system of FIG. 1 to a network employing VLANs in accordance with an embodiment of the present invention;

FIG. 3 is a block diagram illustrating some of the components of a controller system installed on the computer system of FIG. 1 and implemented to enable teaming of network resources in accordance with an embodiment of the invention;

FIG. 4A is a block diagram illustrating network resources of the computer system of FIG. 1 configured as a NFT team in accordance with an embodiment of the invention;

FIG. 4B is a block diagram the NFT team of FIG. 4A after a failover condition in accordance with an embodiment of the invention;

FIG. 5A is a block diagram illustrating network resources of the computer system of FIG. 1 configured as a TLB team in accordance with an embodiment of the invention;

FIG. 5B is a block diagram illustrating network resources of the computer system of FIG. 1 configured as a SLB team in accordance with an embodiment of the invention;

FIG. 6 is a screen shot illustrating a configuration GUI in accordance with an embodiment of the invention;

FIG. 7 is a screen shot illustrating a configuration GUI in accordance with an embodiment of the invention;

FIGS. 8A-8F is a procedural flow diagram illustrating an embodiment of a resource configuration and allocation application in accordance with an embodiment of the invention.

### NOTATION AND NOMENCLATURE

Certain terms are used throughout the following description and in the claims to refer to particular features, apparatus, procedures, processes and actions resulting therefrom. For example, the term network resources is used to generally denote network interface hardware such as network interface cards (NICs) and other forms of network adapters known to those of skill in the art. Moreover, the term NIC or network adapter may refer to one piece of hardware having one port or several ports. While effort will be made to differentiate between NICs and NIC ports, reference to a plurality of NICs may be intended as a plurality of interface cards or as a single interface card having a plurality of NIC ports. Those skilled in the art may refer to an apparatus, procedure, process, result or a feature thereof by different names. This document does not intend to distinguish between components, procedures or results that differ in name but not function. In the following discussion and in the claims, the terms “including” and “comprising” are used in an open-ended fashion, and thus should be interpreted to mean “including, but not limited to . . . ”

### DETAILED DESCRIPTION

The following discussion is directed to various embodiments of the invention. Although one or more of these embodiments may be preferred, the embodiments disclosed should not be interpreted as, or otherwise be used for limiting the scope of the disclosure, including the claims, unless otherwise expressly specified herein. In addition, one skilled in the art will understand that the following description has broad application, and the discussion of any particular embodiment is meant only to be exemplary of that embodiment, and not intended to intimate that the scope of the disclosure, including the claims, is limited to that embodiment. For example, while the various embodiments may employ one type of network architecture and/or topology, those of skill in the art will recognize that the invention(s) disclosed herein can be readily applied to all other compatible network architectures and topologies.

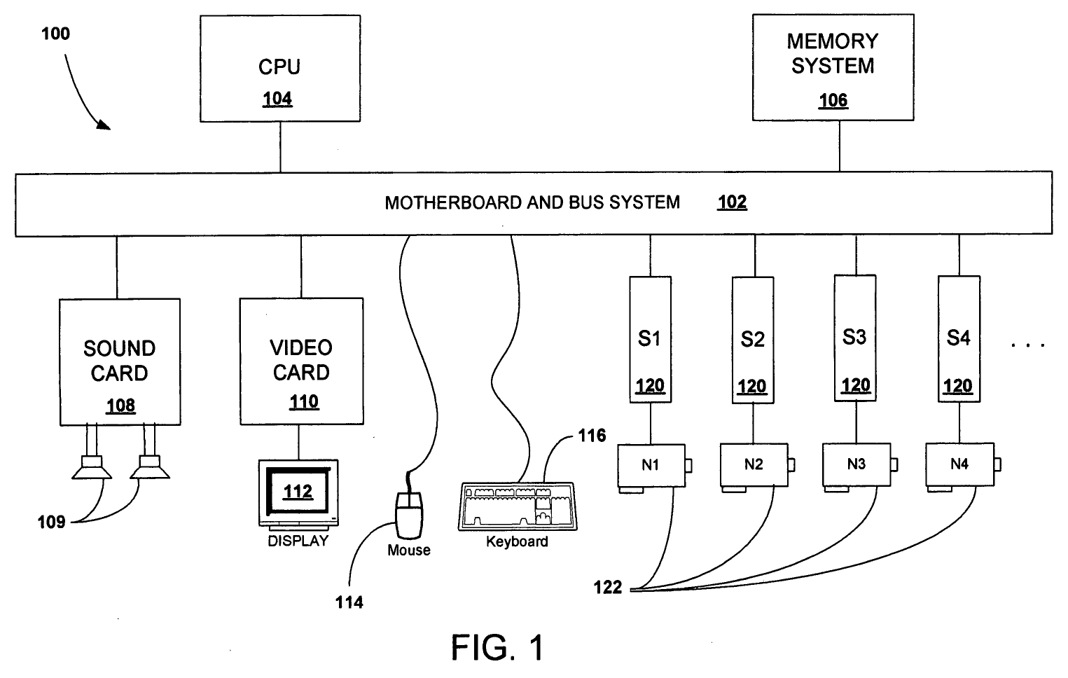

FIG. 1 is a block diagram of a computer system 100 that illustrates various features of a computer system 100, including some of those features used to couple it to a network in accordance with an embodiment of the present invention. The computer system 100 can be an IBM-compatible, personal computer (PC) system or the like, and may include a motherboard and bus system 102 coupled to at least one central processing unit (CPU) 104, a memory system 106, a video card 110 or the like, a mouse 114 and a keyboard 116. The motherboard and bus system 102 can be any kind of bus system configuration, such as any combination of the following: a host bus, one or more peripheral component interconnect (PCI) buses, an industry standard architecture (ISA) bus, an extended ISA (EISA) bus, a microchannel architecture (MCA) bus, etc. Also included but not shown are bus driver circuits and bridge interfaces, etc., as are known to those skilled in the art.

The CPU 104 can be any one of several types of microprocessors and can include supporting external circuitry typically used in PCs. The types of microprocessors may include the 80486, Pentium®, Pentium II®, etc. all microprocessors from Intel Corp., or other similar types of microprocessors such as the K6® microprocessor by Advanced Micro Devices. Pentium® is a registered trademark of Intel Corporation and K6® is a registered trademark of Advanced Micro Devices, Inc. The external circuitry can include one or more external caches (e.g. a level two (L2) cache or the like (not shown)). The memory system 106 may include a memory controller or the like and may be implemented with one or more memory boards (not shown) plugged into compatible memory slots on the motherboard, although any memory configuration is contemplated. The CPU 104 may also be a plurality of such processors operating in parallel.

Other components, devices and circuitry may also be included in the computer system 100 that are not particularly relevant to embodiments of the present invention and are therefore not shown for purposes of simplicity. Such other components, devices and circuitry are typically coupled to the motherboard and bus system 102. The other components, devices and circuitry may include an integrated system peripheral (ISP), an interrupt controller such as an advanced programmable interrupt controller (APIC) or the like, bus arbiter(s), one or more system ROMs (read only memory) comprising one or more ROM modules, a keyboard controller, a real time clock (RTC) and timers, communication ports, non-volatile static random access memory (NVSRAM), a direct memory access (DMA) system, diagnostics ports, command/status registers, battery-backed CMOS memory, etc. Although the present invention is illustrated with an IBM-compatible type PC system, it is understood that the present invention is applicable to other types of computer systems and processors as known to those skilled in the art.

The computer system 100 may further include one or more output devices, such as speakers 109 coupled to the motherboard and bus system 102 via an appropriate sound card 108, and monitor or display 112 coupled to the motherboard and bus system 102 via an appropriate video card 110. One or more input devices may also be provided such as a mouse 114 and keyboard 116, each coupled to the motherboard and bus system 102 via appropriate controllers (not shown) as is known to those skilled in the art. Other input and output devices may also be included, such as one or more disk drives including floppy and hard disk drives, one or more CD-ROMs, as well as other types of input devices including a microphone, joystick, pointing device, etc. The input and output devices enable interaction with a user of the computer system 100 for purposes of configuration, as further described below.

The motherboard and bus system 102 is typically implemented with one or more expansion slots 120, individually labeled S1, S2, S3, S4 and so on, where each of the slots 120 is operable to receive compatible adapter or controller cards configured for the particular slot and bus type. Typical devices configured as adapter cards include network interface cards (NICs), disk controllers such as a SCSI (Small Computer System Interface) disk controller, video controllers, sound cards, etc. The computer system 100 may include one or more of several different types of buses and slots known to those of skill in the art, such as PCI, ISA, EISA, MCA, etc. In an embodiment illustrated in FIG. 1, a plurality of NIC adapter cards 122, individually labeled N1, N2, N3 and N4 are shown coupled to the respective slots S1-S4. The bus implemented for slots 120 and the NICs 122 is typically dictated by the design of the adapter card itself

As described more fully below, each of the NICs 122 enables the computer system to communicate through at least one port with other devices on a network to which the NIC ports are coupled. The computer system 100 may be coupled to at least as many networks or VLANs (virtual LANs) as there are NICs (or NIC ports) 122. Additionally, two or more of the NICs (or NIC ports) 122 may be coupled to the same network or VLAN as a fault tolerant or load balancing team via a common network device such as a hub or a switch. In the case of VLANs, the switch is one that supports such network segmentation. VLAN switches are typically programmable via a standard protocol known to those of skill in the art as Generic Attribute VLAN Registration Protocol (GVRP). When multiple NICs or NIC ports 122 are coupled to the same network or VLAN as a team, each provides a separate and redundant link to that same network or VLAN for purposes of load balancing and/or fault tolerance.

If employed in a packet-switched network, each of the NICs 122 (N1-N4) of FIG. 1 transmits to and receives from the network, packets (e.g. Ethernet® formatted packets or the like) generated by the processing resources of the transmitting network device. The formatting of the packets is defined by the chosen transmission protocol as previously discussed. It will be understood by those skilled in the art that each device on a network uses one or more unique addresses by which it communicates with the other devices on the network. Each address corresponds to one of the layers of the OSI model and is embedded in the packets for both the source device as well as the destination device. Typically, a device will use an address at layer 2 (the data link layer) known as a MAC (media access control) address and an address at layer 3 (the network layer) known as a protocol address (e.g. IP, IPx AppleTalk, etc.). The MAC address can be thought of as being assigned to the physical hardware of the device (i.e. the adapter or NIC port providing the link to the network) whereas the protocol address is assigned to the software of the device. When multiple protocols reside on the same network device, a protocol address is usually assigned to each resident protocol.

For Ethernet® networks, devices communicate directly using their respective MAC (i.e. layer 2) addresses, even though the software for each device initiates communication with one or more other network devices using their protocol addresses. Ethernet® devices must first ascertain the MAC address corresponding to a particular protocol address identifying a destination device. For the IP protocol, this is accomplished by first consulting a cache of MAC address/protocol address pairs maintained by each network device. If an entry for a particular protocol address is not there, a process is initiated whereby the sending device broadcasts a request to all devices on the network for the device having the destination protocol address to send back its MAC address. This is known as ARP (address resolution protocol), the result of which is then stored in the cache. The packets are then formed by embedding the source and destination addresses, which are at least 48 bits, as well as embedding the source and destination protocol addresses in the payload of the packet so that the receiving device knows to which device to respond. For the IPX protocol, the ARP process is not required because the MAC address is a constituent of the IP address.

There are three types of layer 2 and layer 3 addresses. A directed or unicast packet includes a specific destination address that corresponds to a single network device. A multicast address corresponds to a plurality of devices on a network, but not all of them. A broadcast address, used in the ARP process for example, corresponds to all of the devices on the network. A broadcast bit is set for broadcast packets, where the destination address is all ones (1's). A multicast bit in the destination address is set for multicast packets.

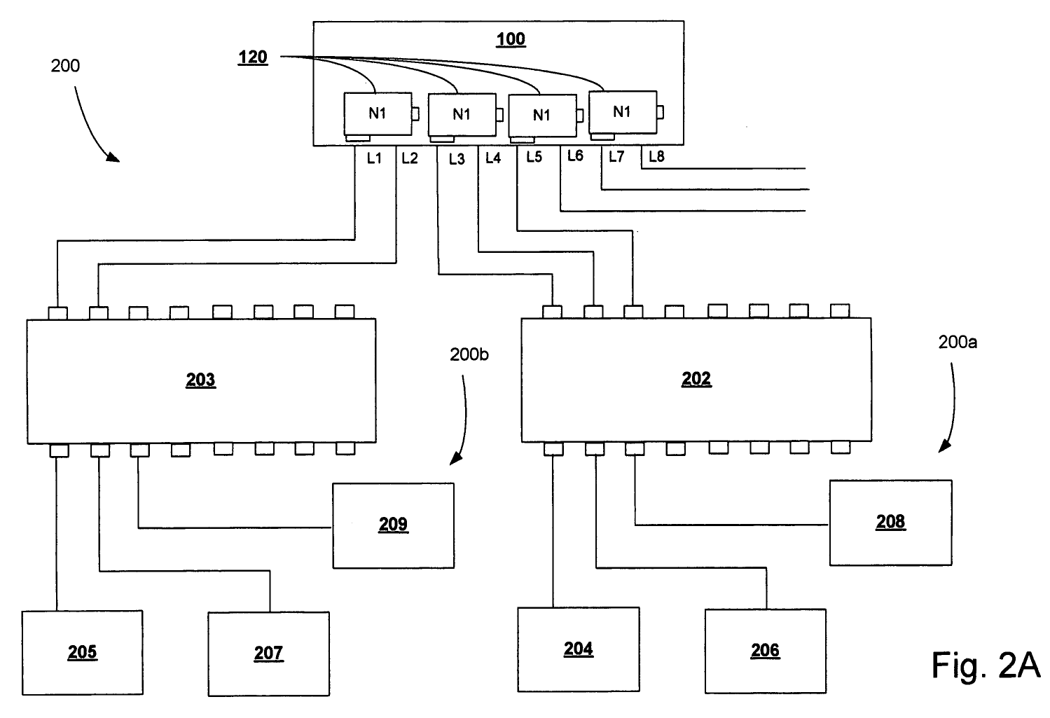

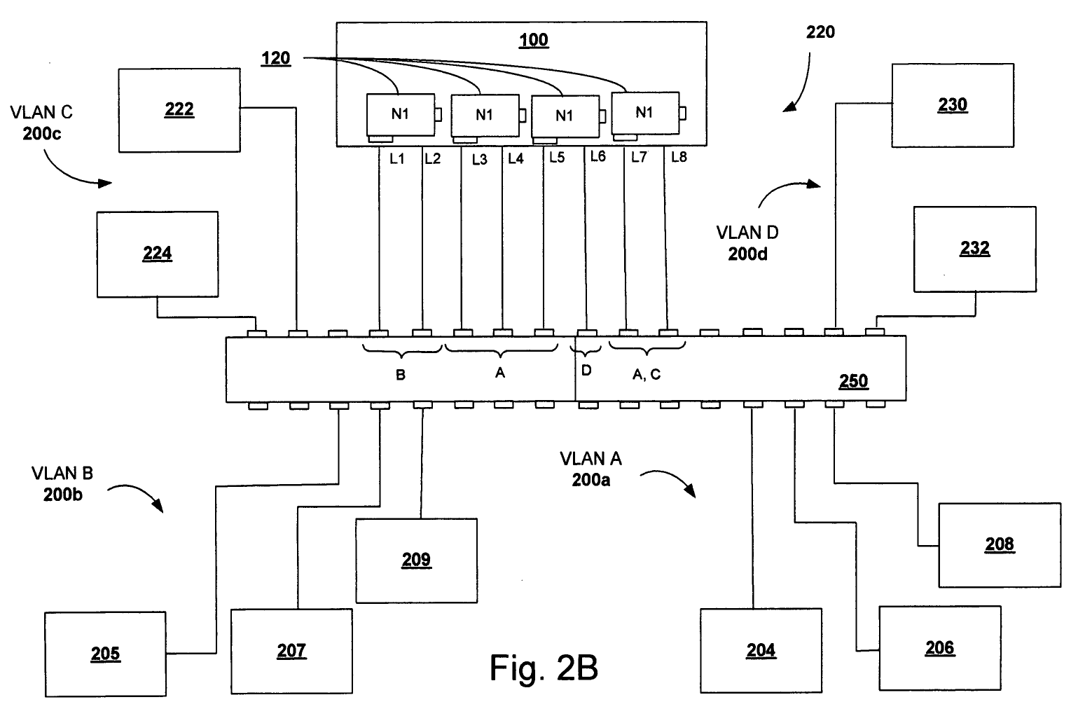

Referring now to FIG. 2A, a block diagram of a network 200 that includes two separate “layer 2” sub-networks 200a and 200b is shown. Computer system 100 communicates with one or more other devices, such as devices 204, 206, and 208 through network device 202 over layer 2 sub-network 200a and devices 205, 207, 209 through network device 203 over layer 2 sub-network 200b. The devices 204 through 209 may be of any type, such as another computer system, a printer or other peripheral device, or any type of network device, such as a hub, a repeater, a router, a brouter, etc. Multiple port network devices 202, 203 can be for example a concentrator, hub, switch or the like. The computer system 100 is coupled to ports of the network device 202 via a plurality of links L3, L4 and L5. The computer system 100 is further coupled to the network device 203 via links L1, and L2. Links L6-L8 are available, but are shown as currently not allocated. The NICs N1-N4 are shown to provide two NIC ports (and thus two links) each. As previously discussed, these NICs may also be single-port devices or a combination of both single and multi-port NICs as well. It is noted that the computer system 100 may be coupled to the network devices 202, 203 via any number of links from one to some maximum number such as sixteen (16), primarily limited by the number of expansion slots available.

In the network of FIG. 2A, devices 204, 206 and 208 are not in communication with devices 205, 207, and 209. When using a transmission protocol such as TCP/IP, devices on these two sub-networks would typically have IP addresses differentiated based on the sub-network on which they reside (e.g. devices on sub-network 200a might have IP addresses 1.x.x.x and devices on sub-network 200b might have IP addresses 2.x.x.x). To provide communication between the sub-networks, they could be coupled together by a network device such as a router or gateway.

The network 220 of FIG. 2B illustrates a known alternative to employing the separate layer 2 sub-networks 200a, 200b of FIG. 2A to subdivide a network. Segmenting the network 220 of FIG. 2B as illustrated does not require more than one network device (i.e. devices 202, 203 as in FIG. 2A). In FIG. 2B, the system 100 is shown to have the same configuration of NICs and the same number of NIC ports as system 100 illustrated in FIG. 2A. In the network of FIG. 2B, however, the network is segmented into virtual LANs or VLANs (VLANs A 220a, B 220b, C 220c and D 220d) rather than using separate layer 2 networks. VLANs A 220a and B 220b of FIG. 2B are analogous to sub-networks 200a, 200b of FIG. 2A respectively. Link L6 (unallocated in FIG. 2A) is shown assigned to communicate as a single member team with VLAN D 220d. Links L7 and L8 (also unallocated in FIG. 2A) are assigned to both VLAN A 220a and VLAN C 220c.

The ports of the network device 250 are programmably coupled internally using a switch protocol such as the aforementioned GVRP. Data formatted in accordance with the configuration protocol is transmitted over each link to programmably couple that link to none, one or more of the other ports of the switch. Each link is thereby internally coupled to the switch ports that are coupled to the devices of each of its assigned VLAN(s). Additionally, the system 100 must also configure itself to ensure that it sends packets destined for a particular VLAN only through those links assigned to that VLAN. This is typically accomplished by building the packets with a VLAN identifier that is associated with each frame to identify the VLAN to which a particular frame of data belongs. Once identified with a particular VLAN, the frame of data is switched within that VLAN using the destination MAC address, just as with any layer 2 LAN network segment. Network devices such as 204-209 can also be programmable switches such as switch 250, thereby permitting hierarchies of such switches.

Those of skill in the art will recognize that one of the advantages of using VLANs in accordance with a topology such as the one of FIG. 2B is that any of the teams of computer system 100 can be programmably configured to talk to one or more different VLAN segments through the same switch 250. In contrast, sub-networks 200a, 200b in FIG. 2A must be coupled to one another through a router or similar device to permit two teams to talk to both networks.

The layer 2 sub-networks 200a and 200b of FIG. 2A as well as VLANs A-D of FIG. 2B may operate according to any network architecture, including but not limited to Ethernet®, Token Ring, etc., or combinations of such architectures. In an embodiment, the layer 2 networks 200a, 200b as well as VLAN segments A-D 220a-d) operate according to an Ethernet® network architecture standard, such as 10BaseT at 10 Megabits per second (Mbps), 100BaseTX at 100 Mbps, 1 Gigabit per second (1 Gbps) or 10 Gigabits per second (10 Gbps). They may be any type of Local Area Network (LAN) or may be part of a Wide Area Network (WAN), and may comprise an intranet and/or may be connected to the Internet. For example, the device 208 (of sub-net 200a, FIG. 2A and VLAN A 220a, FIG. 2B) could be a router or gateway that connects the sub-network 200a to an Internet provider (not shown).

The networks 200 of FIG. 2A and 220 of FIG. 2B illustrate the use of teamed interface resources of the computer system 100 to provide two or more redundant links to each sub-network or VLAN segment. Those of skill in the art will recognize that a single NIC port is sometimes referred to herein as a “one port team” for convenience. A one port team does not typically employ the teaming mechanism described below, but it can be managed by an embodiment of the present invention, including being dynamically reconfigured as a multiple port team with the addition of two or more network resources. Multi-port teams of NIC ports can provide benefits including load balancing and/or fault tolerance. The key to teaming two or more NIC ports is to make the team look like a single virtual interface resource or virtual port to the other devices on the same network or sub-network. This is typically accomplished by assigning one primary MAC address and one protocol (e.g. IP) address to the team. However, the team may have multiple IP addresses assigned to it in the same manner as a single NIC port.

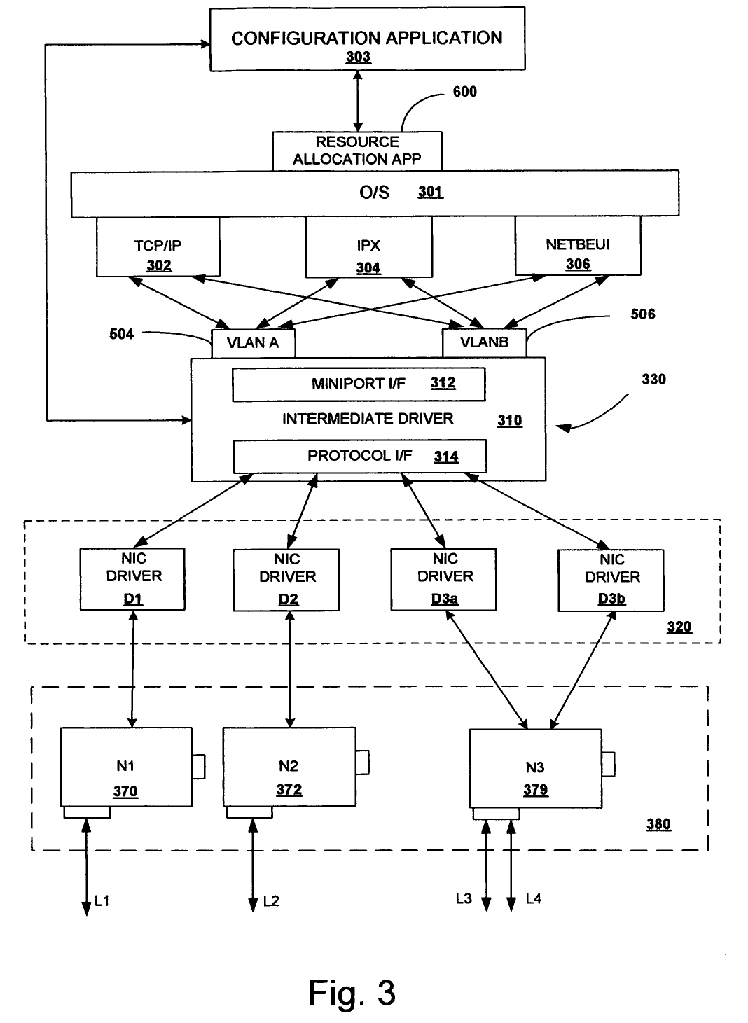

A more detailed discussion regarding the teaming mechanism of an embodiment of the invention is now presented with reference to FIG. 3. As previously mentioned, for a team of network adapter ports to operate as a single virtual adapter, all devices on the network must communicate with the team using only one layer 2 address and one layer 3 address. Put another way, a network device must see only one layer 2 (e.g. MAC) address and one protocol address (e.g. IP, IPX) for a team, regardless of the number of adapter ports that make up the team. For the IP protocol address of an Ethernet network, this means that a team will have only one entry in its ARP table (i.e. one MAC address and one IP address) for the entire team.

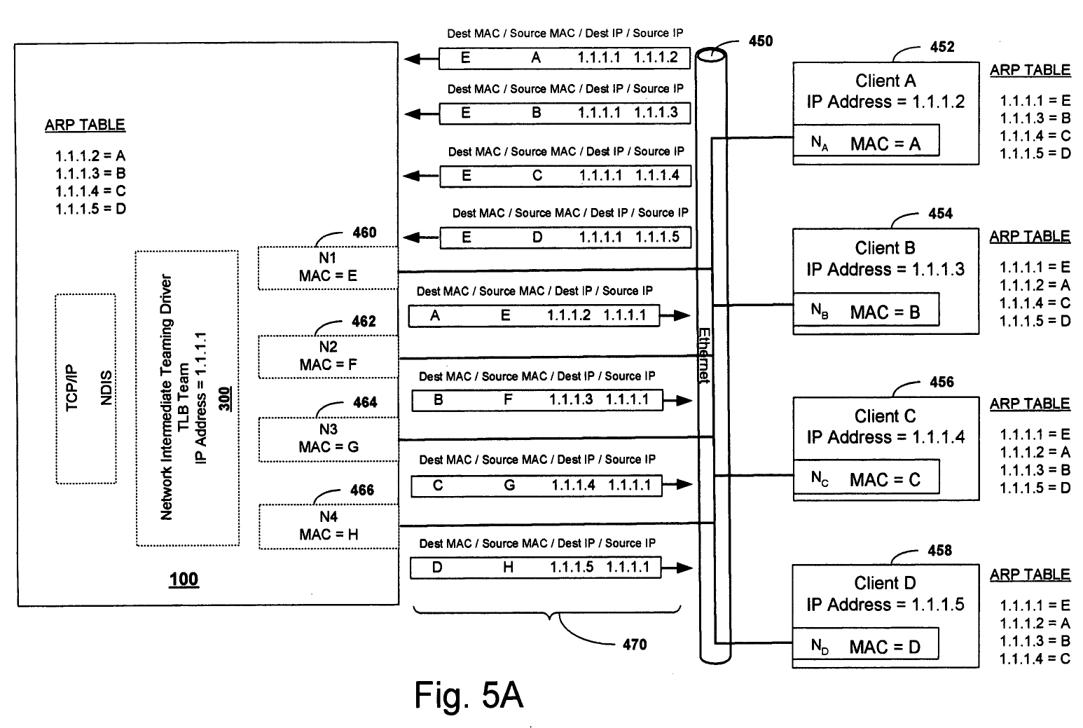

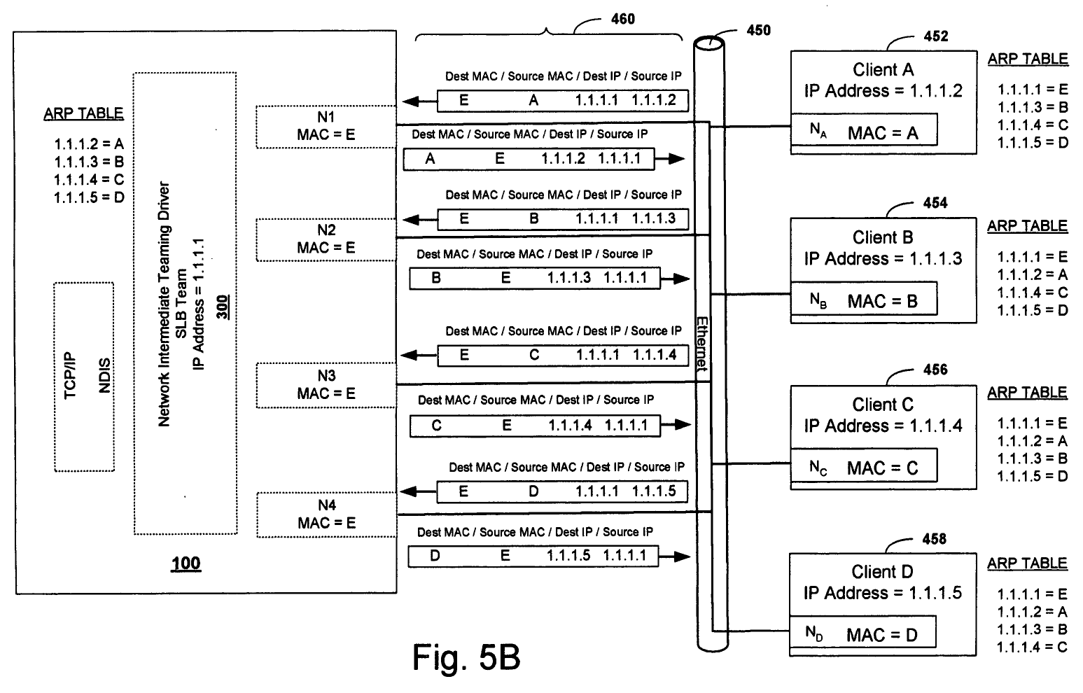

FIG. 3 is a block diagram illustrating the primary components of an embodiment of a controller system 300 installed on the computer system 100 that enables teaming of any number of NIC ports to create a single virtual or logical device. In the embodiment shown in FIG. 5, computer system 100 is configured with four NIC drivers D1, D2, D3a and D3b for purposes of illustration. D1 and D2 are the drivers necessary to control the two single-port NICs N1 370 and N2 372. Drivers D1 and D2 may be instances of the same driver if N1 and N2 are the same NIC, or they may be different drivers if N1 and N2 are different NICs. Drivers D3a and D3b are instances of the same driver corresponding to the two ports of two-port NIC N3 379.

The computer system 100 has installed within it an appropriate operating system (O/S) 301 that supports networking, such as Microsoft NT, Novell Netware, Windows 2000, or any other suitable network operating system. The O/S 301 includes, supports or is otherwise loaded with the appropriate software and code to support one or more communication protocols, such as TCP/IP 302, IPX (Internet Protocol exchange) 304, NetBEUI (NETwork BIOS End User Interface) 306, etc. Two application programs run in conjunction with O/S 301.

An embodiment of configuration application 303 provides a first graphical user interface (GUI) through which users may program in configuration information regarding the initial teaming of the NICs. Additionally, the configuration application 303 receives current configuration information from the teaming driver 310 that can be displayed to the user using the first GUI on display 112, including the status of the resources for its team (e.g. “failed,” “standby” and/or “active”). Techniques for displaying teaming configurations and resource status are disclosed in detail in U.S. Pat. No. 6,229,538 entitled “Port-Centric Graphic Representations of Network Controllers,” which is incorporated herein in its entirety by this reference.

A second GUI is provided through the configuration application through which rules may be enabled or disabled to govern dynamic allocation and configuration of the computer systems teamed NICs based on current network conditions, including current usage of the teamed resources. The second application, resource monitoring and allocation application 600, runs continuously and monitors the status and usage of the system's resources to identify actionable resource usage conditions in response to which it takes action in accordance with the rules that are enabled by the user. The two applications 303 and 600 provide commands by which the resources are allocated and reconfigured. A user can interact with the configuration program 303 through the GUIs via one or more input devices, such as the mouse 114 and the keyboard 116 and one or more output devices, such as the display 112.

A hierarchy of layers within the O/S 301, each performing a distinct function and passing information between one another, enables communication with an operating system of another network device over the network. For example, four such layers have been added to Windows 2000: the Miniport I/F Layer 312, the Protocol I/F Layer 314, the Intermediate Driver Layer 310 and the Network Driver Interface Specification (NDIS) (not shown). The Protocol I/F Layer 314 is responsible for protocol addresses and for translating protocol addresses to MAC addresses. It also provides an interface between the protocol stacks 302, 304 and 306 interface with the NDIS layer. The drivers for controlling each of the network adapter or NIC ports reside at the Miniport I/F Layer 312 and are typically written and provided by the vendor of the network adapter hardware. The NDIS layer is provided by Microsoft, along with its O/S, to handle communications between the Miniport Driver Layer 312 and the Protocol I/F Layer 314.

To accomplish teaming of a plurality of network adapters, an instance of an intermediate driver residing at the Intermediate Driver Layer 310 is interposed between the Miniport Driver Layer 312 and the NDIS. The Intermediate Driver Layer 310 is not really a driver per se because it does not actually control any hardware. Rather, the intermediate driver makes the group of miniport drivers for each of the NIC ports to be teamed, function seamlessly as one driver that interfaces with the NDIS layer. Thus, the intermediate driver makes the NIC drivers of a team appear to be one NIC driver controlling one NIC port. Prior to the introduction of teaming and the intermediate driver layer 310, a protocol address typically was assigned to each individual network adapter (or NIC) driver at the Miniport Driver Layer 312. In the case of teaming, however, a single protocol address is typically assigned to each instance of the intermediate driver. Thus, the first requirement for teaming has been accomplished with a single protocol address being assigned to each team. For each team of NIC adapter ports, there will be a separate instance of the intermediate driver at the Intermediate Driver Layer 310, each instance being used to tie together those NIC drivers that correspond to the NIC ports belonging to that team.

In this manner, the intermediate driver 310 appears as a single NIC driver to each of the protocols 302-306. Also, the intermediate driver 310 appears as a single protocol to each of the NIC drivers D1, D2 D3a and D3b and corresponding NICs N1-N3. The NIC drivers D1, D2 D3a and D3b (and the NICs N1-N4) are bound as a single team 320 as shown in FIG. 5. Because each instance of the intermediate driver can be used to combine two or more NIC drivers into a team, a user may configure multiple teams of any combination of the ports of those NICs currently installed on the computer system 100. By binding together two or more drivers corresponding to two or more ports of physical NICs, data can be routed through one port or the other or both, with the protocols interacting with what appears to be only one logical device.

Assigning a team to particular VLANs is accomplished by instantiating VLAN virtual interfaces (e.g. VLAN interfaces 502, 504 for a VLAN A and VLAN B respectively) to that team's teaming driver for each VLAN to which the team is assigned. Thus, to the operating system it appears to have two teams by which to communicate with VLANs A and B, with packets destined for each VLAN being routed through their respective VLAN virtual interfaces and ultimately through the same team of resources. VLAN assignment is also accomplished through the GUI's of configuration application 303.

As previously discussed a fault tolerant team is typically employed where the throughput of a single NIC port is sufficient but fault tolerance is important. As an example, the NIC ports providing redundant links L1 and L2 to sub-network 200b and VLAN B 220b, FIG. 2B could be configured as a network fault tolerance (NFT) team. For a NFT team, one of the links (e.g. link LI provided by a first port of the corresponding NIC N1) is initially assigned as the primary and is also designated “active.” The second link of the team (e.g. L2 provided by a second port of NIC N1) is then designated as “secondary” and placed in a “standby” mode. If the active link (i.e. L1) fails or is disabled for any reason, the computer system 100 can detect this failure and switch to link L2 by rendering it the active (and primary) link of the team while placing the failed link L1 in standby mode (and designating it a secondary resource). This process is sometimes referred to as “failover.” Communication between computer system 100 and devices 205, 207, 209 in either FIG. 2A or FIG. 2B is thereby maintained without any significant interruption. Those of skill in the art will recognize that an embodiment can have any number of redundant links in a NFT team, and that one link of the team will be active and all of the others will be in standby.

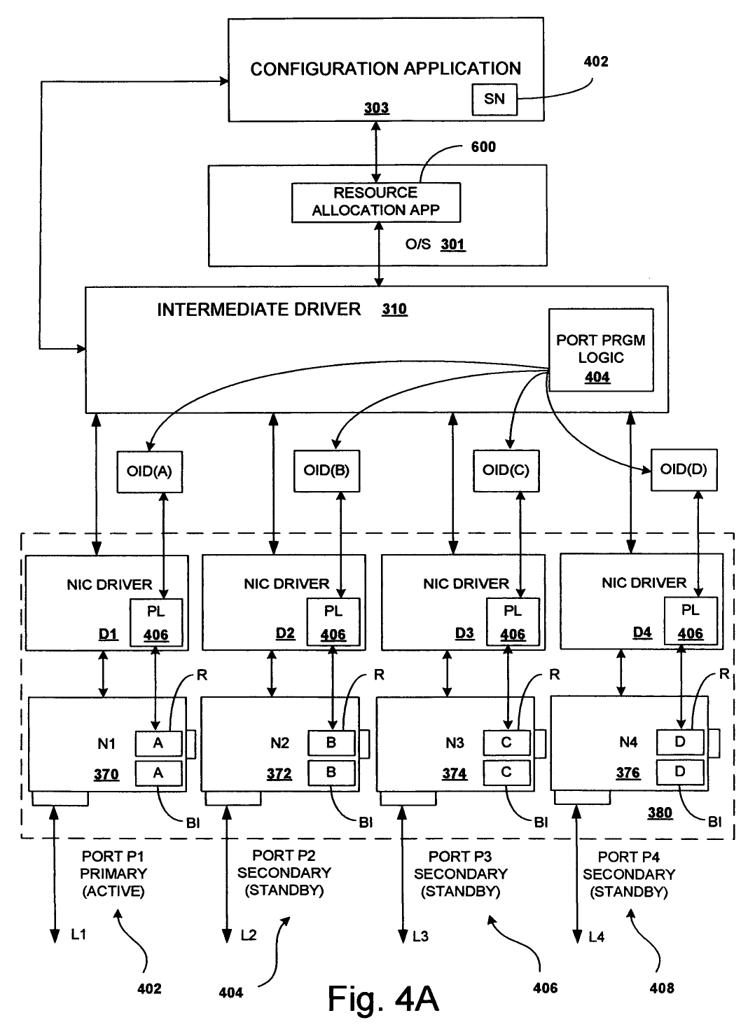

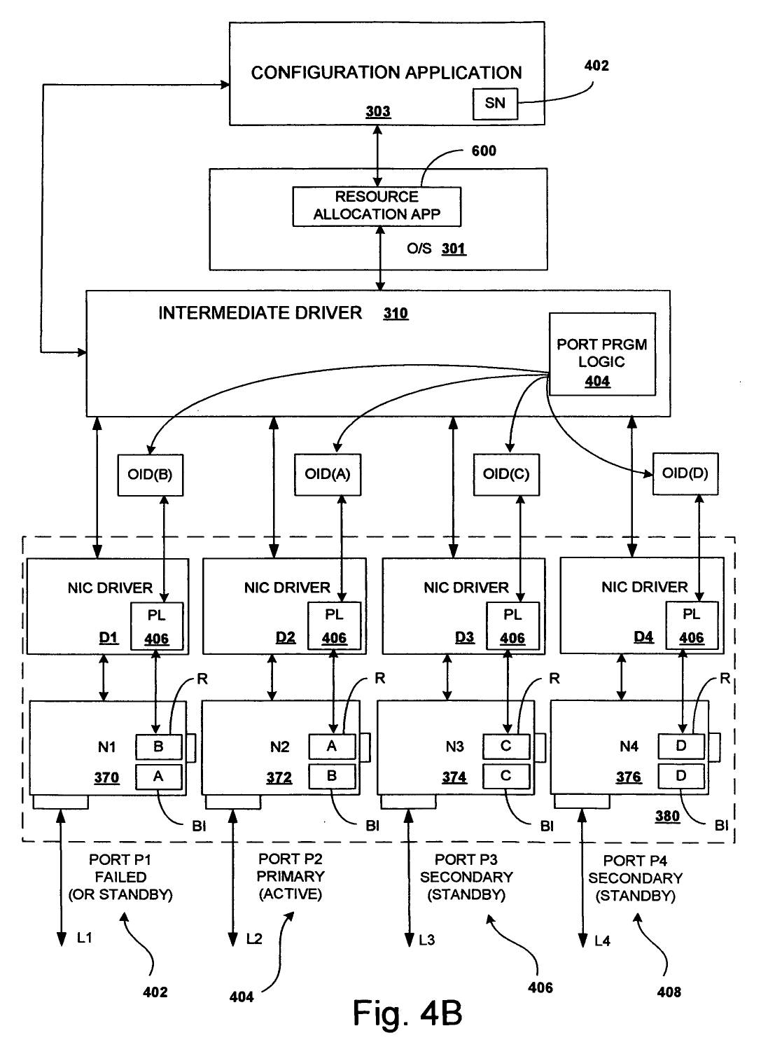

FIG. 4A is a block diagram illustrating an embodiment of system 100 with four single-port NICs that has been configured as a network fault tolerant (NFT) team. An instantiation of the intermediate driver 310 is created for the team upon commands from either configuration application 303 or allocation application 600. Upon initialization, the instance of the teaming driver 310 for the team first reads the BIA (burned-in MAC address) for each member of its team. In FIG. 4A the factory assigned MAC addresses are referred to as A, B, C and D, respectively. The teaming driver then picks one MAC address from the team's pool of BIAs and assigns that to a primary adapter or NIC port. In the example of FIG. 4A, port P1 402 is designated by the teaming driver 310 to be the primary and active port for the team and is assigned the MAC address for the team. The MAC address assigned to port P1 402 is then written to override register R and all of the remaining ports P2-P4 404, 406, 408 become secondary ports that are programmed with one of the remaining MAC addresses from the pool and are initially placed in standby mode. In this case, the MAC address assignments are the same as the BIAs.

The teaming driver 310 includes port program logic 404 that can command the NIC drivers D1-D4 to program the override register R of each of the NICs with the MAC address assignments from the pool. Each of the NIC drivers D1-D4 includes program logic 406 that receives a command, including the override receive address, from the port program logic 404 of the intermediate driver 310. The commands can be issued in the form of an Operation Identifier (OID) to each of the individual NIC drivers D1-D4. Standard NIC drivers are typically designed to recognize a plurality of standard OIDs that are usually sent from the upper level protocols. The override receive address OID used to program the receive address override register is not typically included as a standard OID.

Until the team is reconfigured, the MAC address assigned to the primary adapter is the single MAC address for the team. It should be noted that a user could program the MAC addresses for each of the team members manually. Because there is only one instance of the network teaming ID for each team, and the Layer 3 address is assigned to the ID, there is likewise only one IP address assigned to the team.

If the currently active port becomes disabled or fails for any reason, a failover occurs whereby a secondary or standby port becomes the active and primary port. FIG. 4B illustrates the team of FIG. 4A after a failover. The MAC addresses between ports P1 402 and P2 404 have been swapped and port P2 404 becomes active and the primary for the team. The NIC 370 providing port P1 402 is placed in a standby mode and the failed status of the port P1 402 is communicated by the teaming driver 310 back to the configuration application 303. Likewise, the new active status for the NIC 372 providing port P2 404 is also sent to the configuration application 303. If the network device to which the team is coupled is a hub or a repeater, no other change is necessary. If the network device is a switch, the switch learns that the virtual device (i.e. the team) with source address A has moved from link L1 to L2, and begins sending packets with destination MAC address A to the computer system 100 via the link L2. As previously mentioned, with respect to VLAN switches, the frame includes a VLAN identifier in addition to the destination MAC address. Once associated with a particular VLAN, the frame of data is switched in accordance with the MAC destination address embedded in the frame. Because the two links L1 and L2 are teamed together and assigned to the same VLANs, the VLAN switch will not require reprogramming; it is already programmed to couple all of the links of the team to the same VLANs.

At least three fault tolerance (FT) modes have been provided in the past. In a “Manual” mode, a failover can occur when a “Switch Now” button 402, displayed by the configuration application 303 and the display 112, is activated by the user regardless of whether the active port is actually in a failed state. In a “Switch On Fail” mode, a failover occurs when the system 100 detects that the active port loses link or stops receiving. In a “SmartSwitch” mode, a failover occurs when the active port loses link or stops receiving and switches back to the original active port when that port comes back online (i.e. has been repaired or replaced).

Thus, when operating in the FT Switch On Fail Mode, the intermediate driver 310 detects failure of the primary port P1 402 and fails over to one of the standby ports, such as the port P2 404 and the NIC N2 372 as shown in FIG. 4B. The intermediate driver 310 stays with the new primary port P2 404 until it fails, and if so, selects another operable standby port. If operating in the FT SmartSwitch Mode, after failover from the primary port, such as the port P1 404, the intermediate driver 310 switches back to the previously active port P1 402 if and when the intermediate driver 310 detects the NIC N1 370 is again operable because either it has been repaired or replaced. In any of the fault tolerance (FT) modes, the significant advantage of the single receive address mode is that a failover does not require the entire network to recognize a change of the receive address to that of the new primary port. Because all of ports P1-P4 in the team are programmed with the same receive address A, the failover can occur as soon as the intermediate driver 310 detects failure of the primary port, or as soon as the user presses the switch now button 402 in FT Manual Mode. After the failover as shown in FIG. 4B, the intermediate driver 310 inserts the address A as the source address of the new primary port P2 404, which is properly handled by the network device 200, 203 of FIG. 2A regardless of whether it is a switch, hub or repeater.

As previously mentioned, load balancing teams can be configured to achieve transmit load balancing or both transmit and receive load balancing. Transmit load balancing (TLB) teams are typically employed when fault tolerance is desired as well as throughput greater than that available through the single primary resource port of a NFT team. This is common for situations such as when the computer system 100 is acting as a database server and its primary role is to transmit data to numerous clients. In this example, its receive throughput requirements are significantly less than that of its transmit throughput requirements and the receive throughput requirements can be handled by the primary adapter alone.

As an example, data throughput can be increased between computer system 100 and network devices coupled to a network (e.g. devices 204, 206, 208 coupled to level 2 sub-network 200a, FIG. 2A or the same devices as coupled to VLAN A 220a of FIG. 2B) if the NIC ports providing redundant links L3, L4 and L5 are configured as a load balancing team. For TLB teams, one of the ports is designated the primary port, just as in the case of a NFT team, but in this case all secondary members of the team are also active for transmitting data. The port designated as the primary is responsible for receiving and processing all data sent from the devices 204, 206, 208 back to the computer system 100. The data to be transmitted is balanced among the primary and secondary ports in accordance with any of a number of load balancing algorithms known to those of skill in the art.

Failover for a TLB team is quite similar to that for a NFT team. If failure occurs on a secondary port, it is simply placed in a standby mode and transmit data is re-balanced over one fewer port. If the failed port is the primary, the MAC address for the failed primary is swapped with the MAC address assigned to one of the secondary ports, and the secondary port becomes the primary while the failed port becomes secondary and is placed in a standby mode. The MAC address of the team remains the same.

FIG. 5A illustrates a team configured for transmit load balancing. In this example, NIC N1 460 is designated as the primary. NICs N2 462, N3 464 and N4 466 are also active. Each NIC of system 100 is transmitting with its assigned MAC address as indicated by the addressing information for packets 470 being sent to clients 452, 454, 456 and 458 over network 450. In this example, the traffic is balanced such that each NIC N1-N4 of system 100 is handling the traffic between system 100 and one of the clients 452, 454, 456 and 458. All of the traffic sent from the clients back to computer system 100 is received by primary NIC N1 460 at MAC address E.

SLB teams may be employed in applications where fault tolerance is desired, as well as where throughput greater than that provided by a single network adapter port is required for both transmit and receive data to the computer system 100. One example is when computer system 100 is a server that is backing up other servers and/or clients and thus receives a high volume of data. Transmit and receive load balancing (SLB) employs industry standard technology for grouping multiple network adapter ports into one virtual adapter port and multiple switch ports into one virtual switch port. The algorithm used to balance transmit traffic is typically the same as that used in TLB teams and is still accomplished by computer system 100. The algorithm used to determine to which network adapter port of a receive balanced team to send receive traffic is determined by the particular switch used (a number of switches are commercially available and the algorithm is switch dependent).

FIG. 5B illustrates computer system 100 having network resources configured as an SLB team). In this case, all four NICs 460, 462, 464 and 466 of computer system 100 are assigned the same MAC address E and none of them are designated as a primary. It can be seen that all packets 470 transmitted from or received by computer system 100 over network 450 use the same MAC address E as both source and destination address respectively. Again transmit traffic is balanced by conversation between individual clients 452, 454, 456 and 458, with each NIC N1-N4 handling one of the conversations, just as with the TLB team of FIG. 5A. For the SLB team of FIG. 5B, however, all traffic received by system 100 is also balanced.

It should be noted that for both TLB and NFT teams, all active members of the team transmit data with their own MAC address. This is not a problem for Ethernet networks employing IP as its network protocol because all source MAC addresses are stripped from packets by the receiving network devices and only the team source IP address is used to respond back to the team. For networks employing IPX as a protocol, this is not a problem because the source MAC address is only embedded within the IPX protocol address. During an ARP to a team, only the team MAC address is returned to the requesting device and is stored in its ARP cache.

Various load balancing algorithms are known to those of skill in the art, but they are primarily designed to balance the transmit data on a conversation-by-conversation basis to avoid sending packets out of order. For load balancing to be most effective, each of a team of NIC ports should have the same throughput capability. Otherwise the throughput of all of the NICs of the team will be pulled down to that of the NIC with the lowest bandwidth. For example, if the maximum throughput for the NIC ports providing links L3 and L4 are each 100 Mbps, but the port providing L5 is capable of a maximum throughput of only 10 Mbps, then the aggregate throughput of the team will only be 30 Mbps. If all three ports have a maximum throughput of 100 Mbps, however, then the aggregate throughput of the team will be 300 Mbps. Thus, it may not be advantageous to add a 1 Gbps port to a team including two 100 Mbps ports, as the aggregate maximum throughput will only increase from 200 Mbps to 300 Mbps. Instead, it might be more advantageous to replace the two 100 Mbps NIC ports with the 1 Gbps port as a primary and employ one or both of the 100 Mbps ports as a secondary of a fault tolerant only team.

As previously discussed, resource allocation application 600 runs as a service in conjunction with O/S 301. Application 600 can continuously monitor network resource usage based on packets generated for transmission through the team by the O/S 310 and packets received from the network through each team and processed by the O/S. Allocation application 600 can also monitor network activity through feedback from each team's intermediate teaming driver 310. The allocation application 600 can also monitor the current status of each NIC or NIC port installed within system 100.

Resource status can include (but is not limited to) whether the link it provides has been coupled to a network or to a VLAN of a network, whether it has been configured with other resources as a team, the nature of the team with which it is configured (i.e. NFT, TLB, SLB, etc.) and its current operational status (i.e. failed, active, standby, etc.). Thus an embodiment of resource allocation application 600, in conjunction with the configuration application 303 and intermediate (teaming) driver 310, performs the dynamic allocation of teamed network resources (sometimes referred to herein as dynamic teamed network resource allocation and configuration (DTNRA)).

For the reasons previously discussed, it would be desirable to provide a feature by which network resources may be monitored and more generally reallocated and/or reconfigured dynamically in response to changing network conditions and with minimal physical intervention required of a user. To this end, an embodiment of the application 600 maintains a pool of the installed network resources (e.g. the ports of network adapter cards such as a NIC). Not all of the installed NICs (and their ports) are necessarily part of the pool. Some of the installed resources may in fact be dedicated to some network link that a user wishes to remain outside the dynamic allocation process executed by the allocation application 600. Once a user has placed resources in the pool, they are isolated in an off-limits state so that they are not used inadvertently by the operating system 301 for other purposes. The resource allocation application 600 recaptures resources from teams that no longer need them as a means of preventing an “empty-pool” condition. If an “empty-pool” condition does arise, allocation application 600 can be configured to recapture resources from the team that will be least adversely affected to avoid a total failure condition in a team.

The pool has a “Needs Attention” section into which the resource allocation application 600 places resources (NICs) when it determines that it the resource is “broken” (cable disconnected, etc.) in a manner that application 600 can not fix dynamically. When allocation application 600 places a resource (NIC) into this “Needs Attention” portion of the pool, allocation application 600 can generate an alarm or page to the user/administrator at a priority configured by the user. Thus, the user/administrator need only look in one place for failed NICs. When they have been fixed, allocation application 600 adds them back into the pool, and allocates them back out to teams dynamically as and when needed in accordance with the rules as configured. A user can assign resources to the pool from those installed on system 100, establish criteria (e.g. throughput, desire for redundancy, etc.) by which an initial allocation of resources may be inferred by the application 600, or manually configure an initial configuration of the resources through configuration program 303. This can be accomplished through techniques similar to those disclosed in the above-referenced U.S. Pat. No. 6,229,538 entitled “Port-Centric Graphic Representations of Network Controllers.”

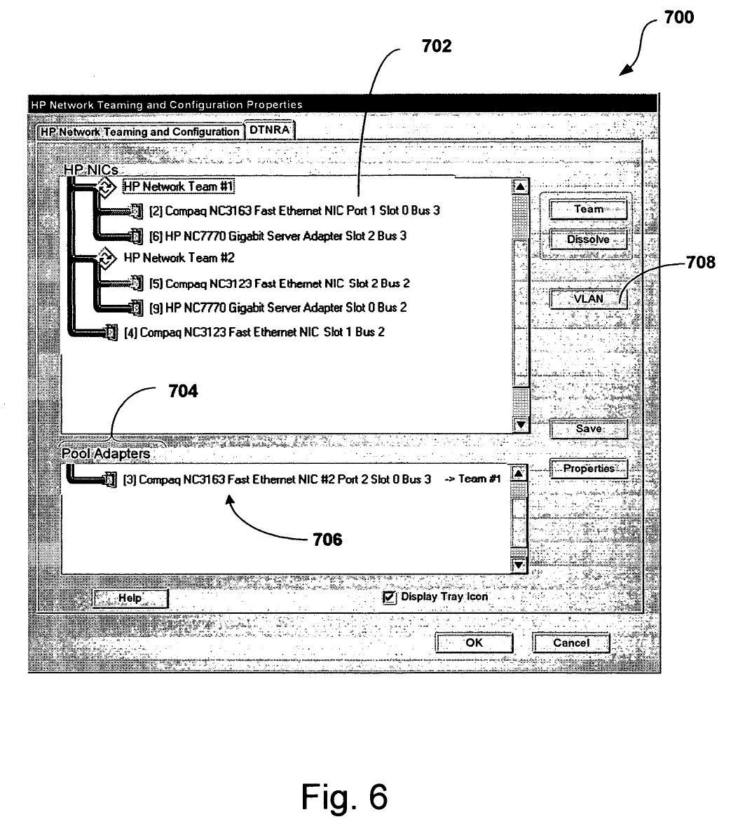

FIG. 6 illustrates an embodiment of a dialog box 700 through which a user might interact with configuration application 303 to allocate resources to the pool, initially allocate resources to teams and to check the current configuration status of resources in the pool or allocated to teams as provided by the teaming driver. The top portion 702 of the dialog box 700 illustrates an initial configuration of the resources installed on a system. The bottom portion illustrates those resources allocated to the pool. Button 708 is provided to assign each team to one or more VLANs. Note that the resource 706 is the second port of a two port NIC, the first port of which is assigned to Network Team#1. The second port is currently allocated to the pool and has been at least temporarily allocated for use with Team#1.

Based on the current network usage, as well as the status of the available and allocated resources, an embodiment of the application 600 dynamically adjusts resource allocation and/or team configuration and/or team behavior in accordance with a set of configurable and extensible rules established by a user. Through these rules, allocation policy is established that can substantially increase efficiency and responsiveness in the allocation of the available interface resources of system 100, while permitting the user some freedom to customize the policy to make tradeoffs in view of goals specific to the user's application and/or environment.

A user can establish desired allocation policy through a user interface (such as a dialog box) presented on display 112, FIG. 1 by the configuration application 303. In an embodiment, allocation policy is established by activating (selecting) or deactivating (deselecting) the available rules by which resources are to be allocated, the nature of teams and their behavior (and when those should be altered, if ever), as well as the recapture of resources to the pool. The rules, including parametric data used to establish thresholds of time and magnitude for enforcement of some of the rules where desirable, are then communicated from the configuration application 303 to the allocation application 600.

In an embodiment of the application program, the rules may include (but are not limited to) the following:

(1) Restore Redundancy

If a NFT team has no available “hot-standby” (i.e. an operational secondary NIC or NIC port that is in mode, teamed in the manner such as in FIG. 4A), add a resource (i.e. NIC or NIC port) from the pool to this team in the manner illustrated in FIG. 4A. This situation might occur if, for example, all of the other team members but the one currently active have failed and have not been repaired. Any non-functional NICs can then be recovered from the team to the pool.

(2) Recapture Underutilized Resources (NICs)

(a) if a NFT team has more than one available/connected “hot-standby” (e.g. such as in the four member NFT team of FIG. 4A), drop all of the resources from the team but one primary and one secondary and return them to the pool; (b) if a TLB or SLB (i.e. an LB) team is underutilized (i.e. its actual aggregate throughput (utilization) falls below a configured threshold (i.e. low-water mark) for some minimum duration of time), drop a resource from this team and return it to the pool; (c) If a TLB/SLB team has a resource that is not being “balanced-across,” drop that resource from the team and return it to the pool. This situation may occur when a load balancing scheme doesn't result in a reasonably equal distribution of frames across all of the NICs in the team, and thus one or more of the NICs are underutilized. In the extreme, for example, if a balance-by-MAC address algorithm is used and all client MAC addresses end in the same digit, the algorithm will always choose the same NIC to transmit; (d) if an LB team has team members, drop the slower speed NIC(s). This can happen, for example, when a load balancing team has two team members having a throughput of 1 Gbps and one team member having a throughput of 100 Mbps (i.e. Gig+Gig+Fast). This team will theoretically achieve a maximum aggregate throughput of only 300 Mbps. If the “Fast” team member is dropped, the team should achieve a maximum throughput of 2 Gbps.

(3) Change Load Balancing Algorithm

If a LB team can achieve a “better balance” using an alternate load balancing algorithm (in view the current traffic usage over a predetermined duration for the originally configured algorithm), change the algorithm to the more favorable algorithm. For example, one algorithm might balance conversations over team members based on IP addresses, while another algorithm might balance conversations over team members based on MAC addresses.

(4) Change Team Type

If a NFT Team has team members all running at the same speed, change the operating mode to a LB team. For example, a Gig+Gig team runs at 1 Gbps as a NFT team, but at 2 Gbps as a LB Team; (b) if a LB Team has disparate speed team members, change the operating mode of the team to NFT and make the member having a greater maximum throughput the primary member. For example, a Gig+Fast Team theoretically runs at a maximum aggregate throughput of only 200 Mbps. However, as a NFT team with the Gig resource as the primary team member, the maximum throughput is 1 Gbps. Thus, change operating mode to NFT and make Gig member the primary for the team.

(5) Add NIC to Saturated LB Team

(a) If a LB team is being fully utilized (i.e. reaches a configured high-water mark of aggregate throughput utilization for a predetermined time duration), add a resource from the pool having the same or greater throughput than the team member having the lowest throughput (if available) to this team. It is desirable for the resource added to have a throughput equal to or greater than the current team member having the lowest throughput because adding one that has less throughput could lead to the team having a maximum aggregate throughput that is less than the aggregate throughput it had prior to the new member being added; (b) If a NFT team is saturated (i.e. the primary is saturated) in accordance with the high water mark and duration and if the other team members have a throughput that is equal to or greater than the primary, change the team type from NFT to TLB.

(6) Increase a NIC's Internal Resources

If a NIC (whether one teamed with others or one that is stand-alone) is low on internal resources (e.g. receive descriptors, buffers, etc.), re-provision/re-configure that NIC.

(7) Replace Stand-Alone NIC on Failure

If a stand-alone (i.e. team-of-one) NIC fails, add a NIC to it to replace the one that failed.

(8) . . . <extensible>. . .

Any additional rule that can be established that results in better utilization of a system's network resources in view of network utilization and resource status.

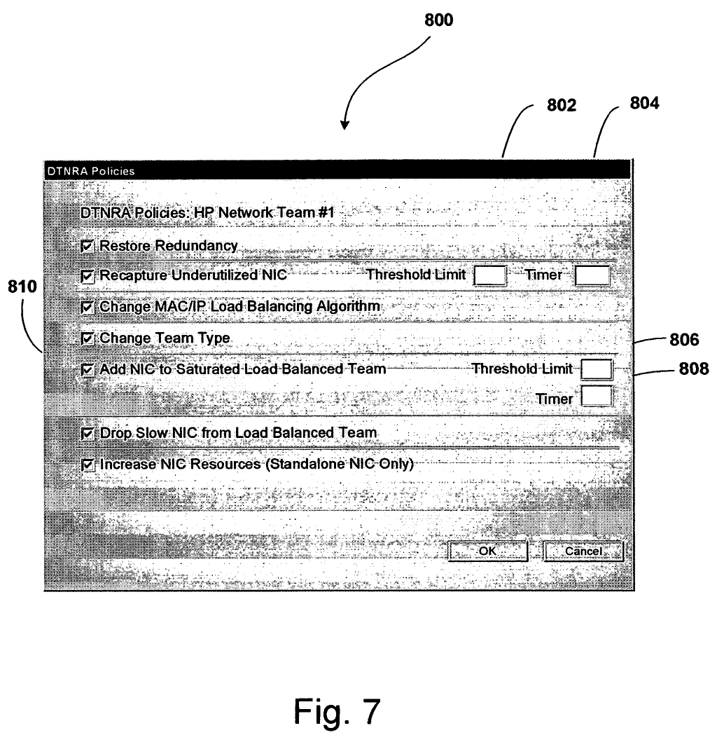

FIG. 7 illustrates an embodiment of a rules dialog box 800 through which a user might interface with the configuration application 303 to establish allocation policy. By enabling or disabling the rules listed on the dialog box on a team-by-team basis, an allocation policy is established for each team configured for the system 100. The rules identify for the allocation application 600 a set of actionable resource usage conditions that will cause the application 600 to take certain actions in response thereto as previously described for each one of a possible set of such rules. Note that some rules may be further parameterized with thresholds (i.e. high 802 and low 806 water marks) as well as time durations 804, 808 for which the condition (e.g. current team throughput) must be above or below the threshold respectively before an actionable condition will be deemed to have occurred.

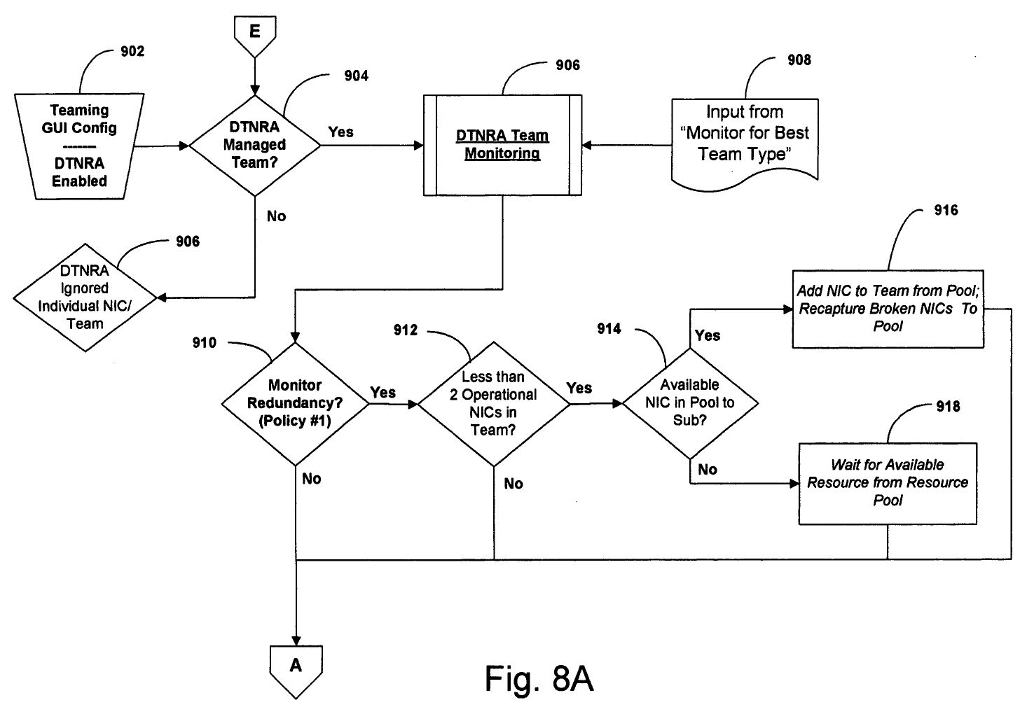

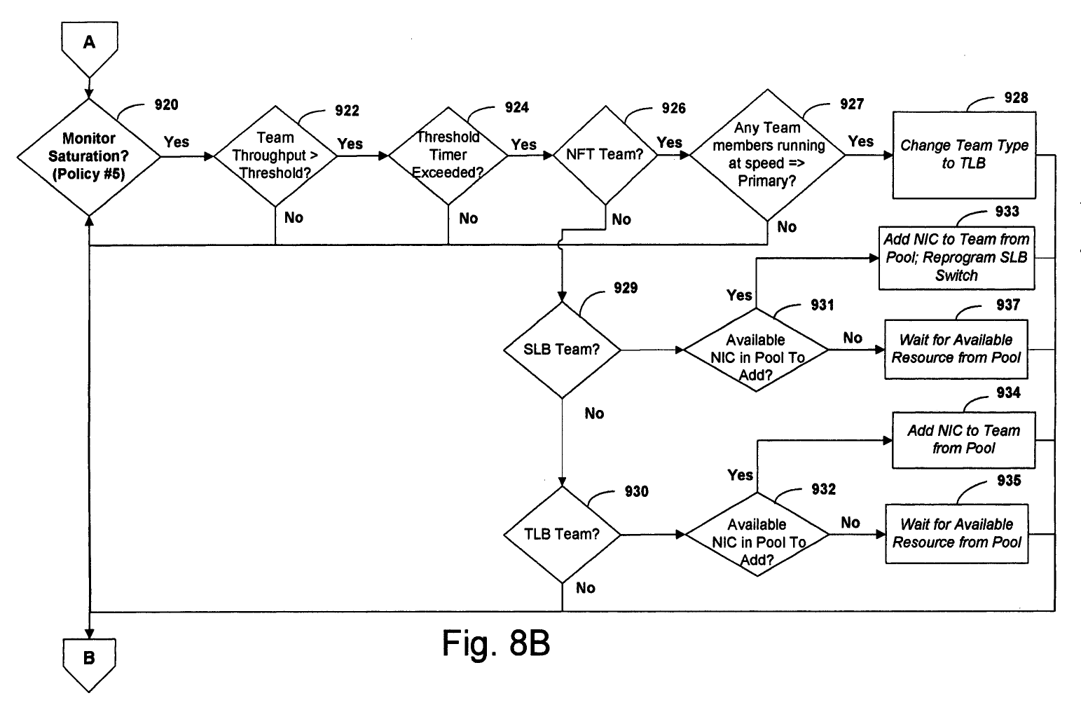

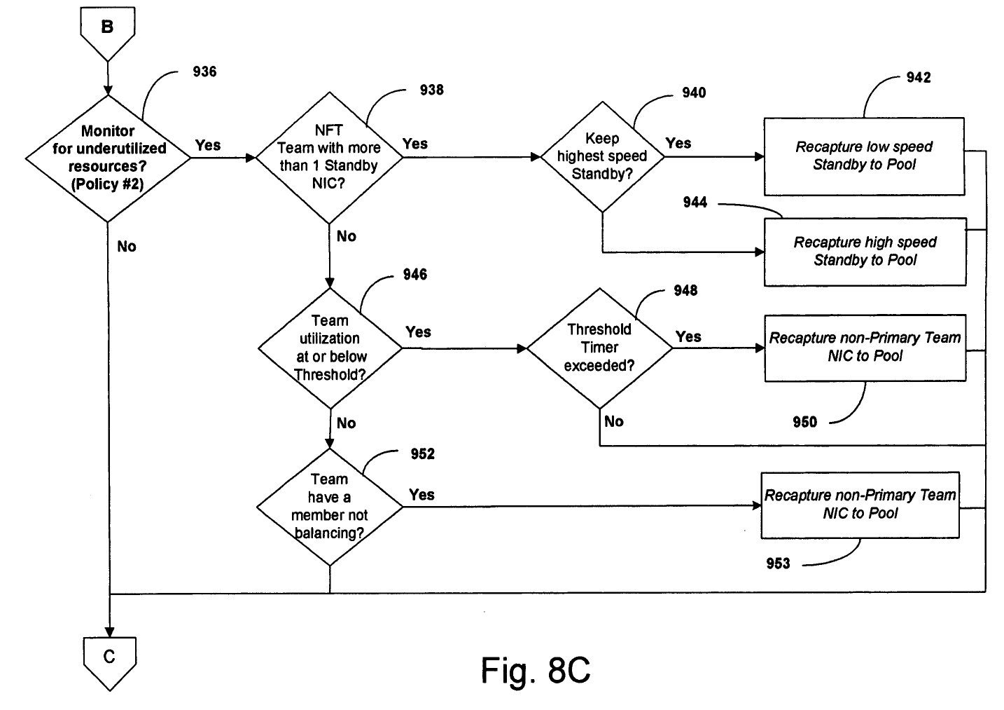

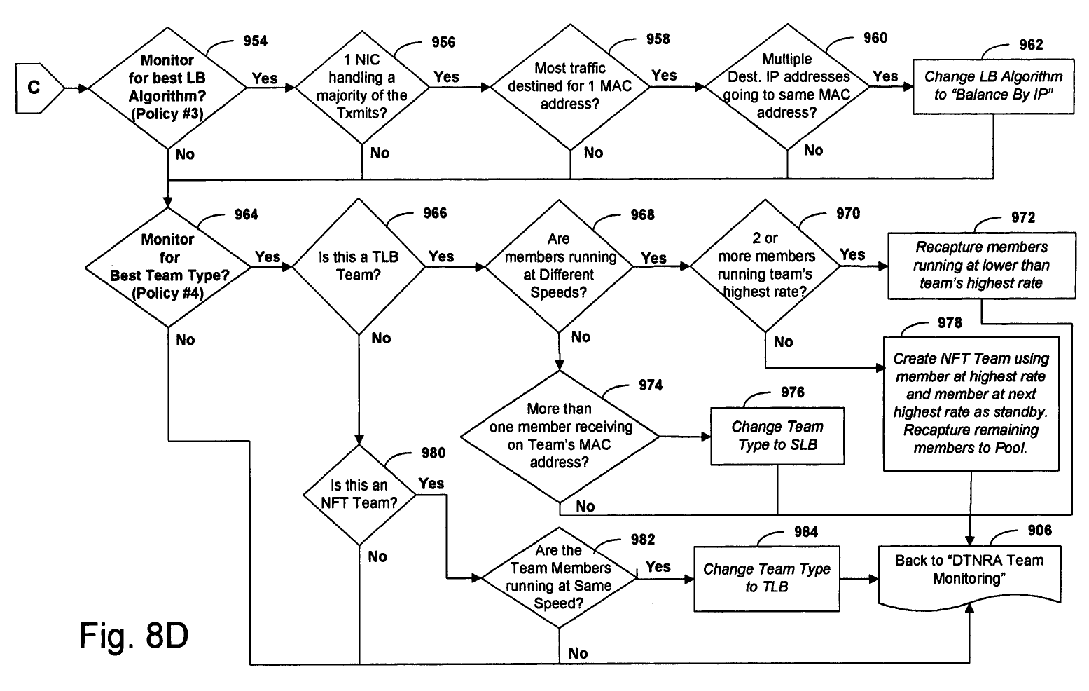

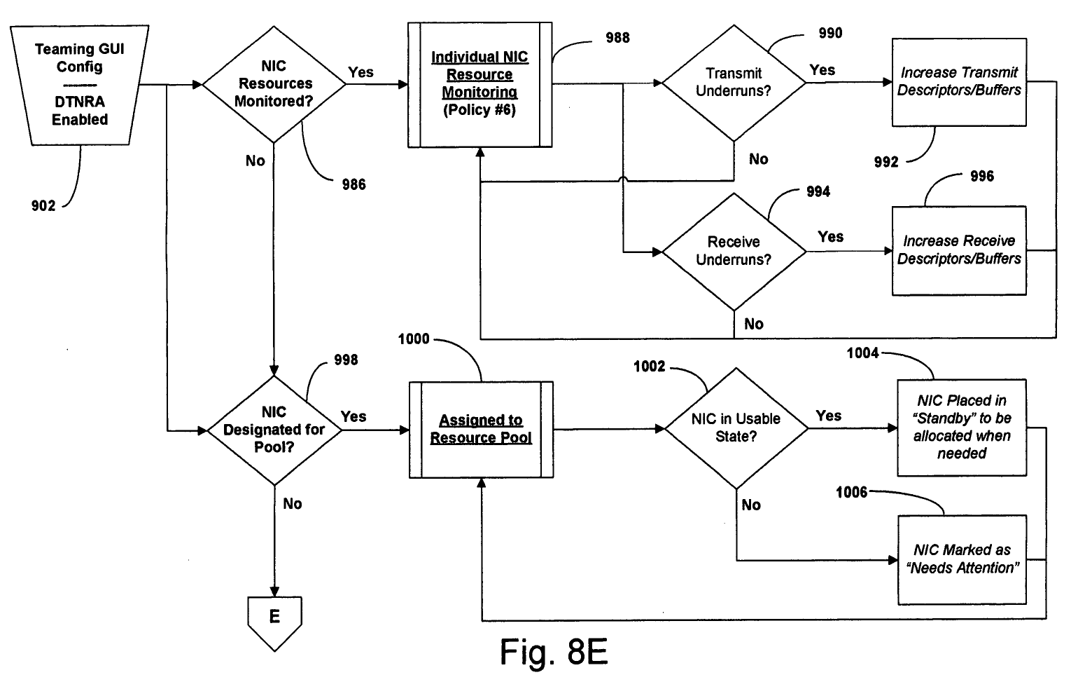

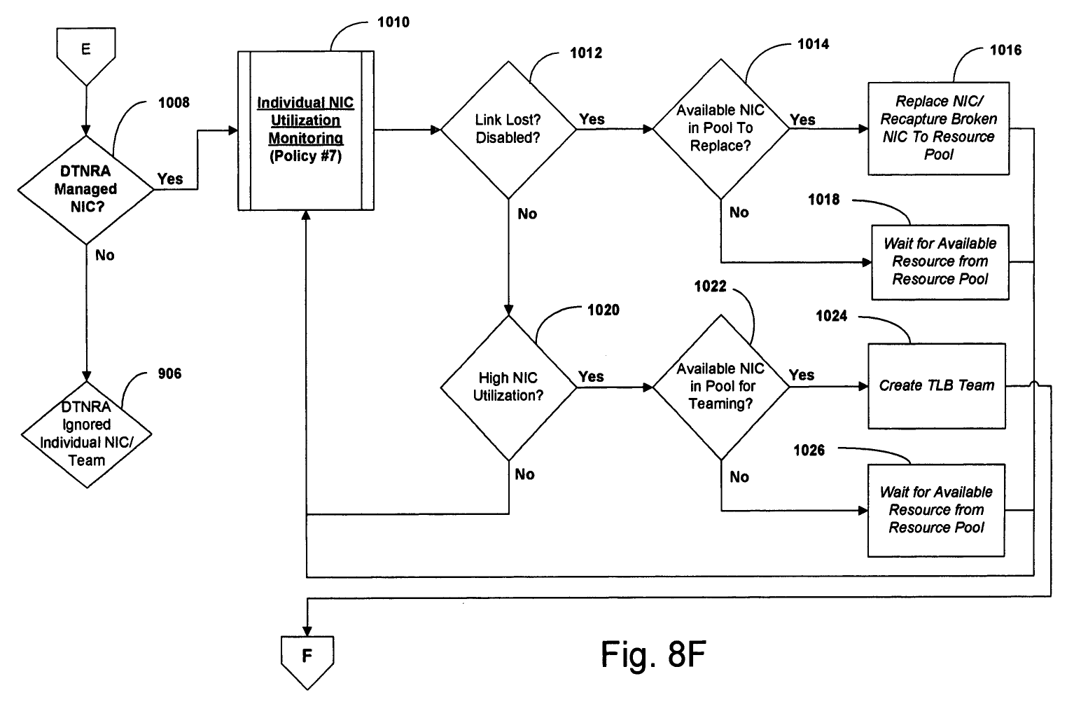

FIGS. 8A-8F illustrate a procedural flow diagram for an embodiment of the resource allocation application 600 of the invention. Starting at 902, FIG. 8A, application 600 receives input from the configuration application 303 regarding enabled rules and rule parameters for each team to be managed dynamically by the application 600. Additional configuration information such as initial team configurations, pool allocations, etc. as discussed above are also provided through configuration application 303. Proceeding at 904 for each team configured for the system, the resource allocation application 600 determines whether the current team is one that is to be managed by it. If “no,” the team is ignored at 906. If the determination is “yes” at 904, the team is checked for actionable conditions based on the user selected and configured rules, current network conditions and resource status as provided to allocation application 600 by O/S 301 and the teaming driver 310 for the team being managed. This process is generally represented by 906 and information regarding the best team type is provided to support the monitoring process as indicated at 908.

If the rule Restore Redundancy was selected the answer to the query at 910 is “yes” and processing continues at 912. If the team has less than two operational NICs, processing continues at 914 where application 600 determines whether there are any additional resources in the pool that can be allocated to the team. If the answer at 914 is “yes” then the available resource from the pool is added to the team and any non-operational resources are recaptured to the pool at 916. The failed resources are indicated as needing attention as previously discussed. If there are no additional resources available from the pool, application 600 addresses the problem as soon as one does become available. Regardless of whether a successful replacement from the pool was found, or if the answer at either 910 or 912 is “no” processing then continues at 920, FIG. 8B.

If the rule Add NIC to Saturated LB Team was selected, the answer at 920 is “yes” and processing then continues at 922, where application 600 determines whether the aggregate throughput of the team (regardless of whether it be a NFT or a LB team) has exceeded the threshold specified with the rule and for the duration of time specified with the rule. If the answer is “yes” then processing continues at 926 where application 600 determines whether the team is a NFT team. If “yes” then it is determined at 927 if the secondary resources have a throughput that is equal to or greater than that of the primary team member. If the answer is “yes” then application 600 changes the team type from NFT to a LB and processing continues at 936. If the answer is “no” at 927, processing continues at 936, FIG. 8C. If the answer at 926 is “no” then processing continues at 929 where it is determined whether the team is a SLB team. If yes, the processing continues at 931 where application 600 determines whether a resource is available in the pool that can be added to the team. If “yes” then application 600 instructs the teaming driver to add the resource from the pool at 934. The teaming driver 310 also reprograms the SLB switch to make sure the switch recognizes the added resource. The programming can be accomplished through use of a programming protocol such as PAgP protocol for Cisco EtherChannel or LACP for 802.3ad Port Trunking. Processing then resumes at 936, FIG. 8C. Part of the determination at 931 can also include whether the available resource has a maximum throughput that is equal to or greater than the maximum throughput of the member of the team having the lowest maximum throughput. Otherwise, the aggregate throughput of the team might be significantly lowered by such an addition, which is not the goal of the policy established by the rule. If the answer is “no” at 931, then the application 600 will watch for a resource to become available in the pool at 937 and will add it when it becomes available and continue processing at 936, FIG. 8C.

If the answer at 929 is “no” then processing resumes at 930, FIG. 8C where it is determined whether the team is a TLB team. If “yes,” processing continues at 932, where application 600 determines whether a resource is available in the pool that can be added to the TLB team. If “yes” then application 600 instructs the teaming driver to add the resource from the pool at 934 and processing resumes at 936, FIG. 8C. Once again, part of this determination at 932 can be whether the available resource has a maximum throughput that is equal to or greater than the maximum throughput of the member of the team having the lowest maximum throughput. Otherwise, the aggregate throughput of the team might be significantly lowered by such an addition, which is not the goal of the policy established by the rule. If the answer is “no” at 932, then the application 600 will watch for a resource to become available in the pool at 935 and will add it when it becomes available and continue processing at 936, FIG. 8C. If the answer at 930 is “no” then processing resumes at 936, FIG. 8C.

If the rule Recapture Underutilized Resources (NICs or NIC ports) was selected, the answer at 936 is “yes” and processing then continues at 938 where application 600 determines whether the team under consideration is a NFT team with more than one operational secondary resource (i.e. hot standby). If “yes” then the application 600 decides at 940 whether to keep the team member with the highest throughput. The basis for this determination can be whether all of the redundant resources have the same throughput or whether the highest speed standby team member is greater than or equal to the primary throughput. Another basis might be that there is a pending need (e.g. at 918 or 935) for a resource having a throughput equal to the highest speed standby team member to be returned to the pool. If the answer at 940 is “yes” then the lower speed members are recaptured to the pool at 942 and processing continues at 954, FIG. 8D. If the answer is “no” then the highest speed standby team members are recaptured to the pool at 944 and processing continues at 954, FIG. 8D. If the answer at 938 is “no” then processing continues at 946 where application 600 determines whether the LB team is at or below the threshold (i.e. low water mark) current for utilization. If “yes” then it is determined whether the low water mark has been reached or exceeded for the duration specified. If “yes” then one of the secondary resources is recovered for the pool at 950 and processing resumes at 954, FIG. 8D. If the duration has not been exceeded at 948, then processing resumes at 954, FIG. 8D. If the threshold has not been reached or exceeded at 946, processing continues at 952 where application 600 determines whether any of the secondary team members of the TLB team are not operating to balance transmit packets. if “yes” the secondary resource not properly balancing data is recovered to the pool at 953 and if inoperable is marked as such. If “no” then processing resumes at 954, FIG. 8D.

If the rule Change Load Balancing Algorithm was selected then the answer at 954 is “yes” and processing continues at 956 where application 600 determines whether one of the team members of a LB team is handling most of the transmits. If “no” processing continues at 964, but if “yes” then it is determined whether most of the transmit traffic is destined for one MAC address. If “yes” then processing continues at 960 where it is determined whether there are packets being transmitted by the team that have multiple IP destination addresses but to the same destination MAC address. If “no” then processing continues at 964, and if “yes” then the application 600 changes the LB load balancing address to a balance based on IP address type algorithm at 962 and processing continues at 964. Typically it is best to use IP balancing if the system is running the IP protocol. MAC address load balancing is typically used only for cases where a protocol other than IP is being run (e.g. AppleTalk, NetBEUI, IPx, etc.).

If the rule Change Team Type was selected then the answer at 964 is “yes” and processing continues at 966 where the application 600 determines if the team being currently managed is a TLB team. If “yes” then processing continues at 968 where it is determined if the team members are running at disparate maximum throughputs. If “yes” then it is determined at 970 if there are two or more members running at a highest throughput. If “yes,” then any team members running at less than the highest throughput are recovered back to the pool at 972 and processing returns back to 906. If the answer at 970 is “no” then a NFT team is created at 978 using the fastest team member as the primary and one member with a slower throughput as the standby for the team. The remaining slower members, running at speeds slower than the primary, are recovered to the pool and processing resumes at 906. If the answer at 976 is “no,” application 600 determines whether more than one member of the team is receiving packets with the team's MAC address as the destination address. If “yes” the team is changed to a SLB team at 976 and processing resumes at 906. If the answer at 966 is “no” it is determined at 980 if the team is a NFT team. If “no” then processing continues at 906, but if “yes” than it is determined at 982 if the team members of the NFT team have the same maximum throughput. If the answer is “yes” then the team is converted to a TLB team. If the answer is “no” then processing resumes at 906.

If the rule Increase a NIC's Internal Resources was selected, then the answer at 986, FIG. 8E is “yes” and processing is resumed at 988 and individual resource monitoring is enabled and processing resumes at 990 where the application 600 determines whether a particular NIC is experiencing transmit underruns. If “no” then monitoring continues at 988 but if “yes,” then the transmit/descriptor buffers of the individual adapter card are increased at 992 and individual NIC monitoring continues at 988. Additionally, individual NICs are monitored for receive overruns and if detected for a particular NIC, its receive descriptor buffers are increased at 996.

If the foregoing rule was not enabled, processing continues at 998 where application 600 determines whether an individual NIC or adapter card has been designated for the pool, either initially or as part of the recapture process associated with the procedures outlined above. If the answer is “no” then processing continues at 1008, FIG. 8F. If the answer is “yes” then application 600 determines whether the NIC is operational at 1002. If “yes” then it is placed in the pool in standby mode at 1004 and awaits possible reallocation as described above. If it is not operable, it is placed in the “Needs Attention” section of the pool at 1006 and the user is notified either by feedback to the user interface of the configuration program and possibly by some higher priority method as previously mentioned.

If the rule Replace Stand-Alone NIC on Failure was selected then the answer at 1008 is “yes” and the application 600 the monitoring of stand-alone or one NIC teams is enabled at 1010. In this case, processing continues at 1012 where it is determined if link has been lost for the one NIC of the team and if “yes” it is determined whether there are any NICs available in the pool at 1014. If yes, then the inoperable NIC is replaced with an operable one from the pool and the inoperable one is recaptured to the pool at 1016 and monitoring continues at 1010. If the answer at 1014 was “no” then application 600 performs the replacement process when one becomes available to the pool. If the answer at 1012 is “no” then it is determined if the single NIC has been saturated or is in heavy use, then it is determined whether an appropriate NIC is available in the pool for teaming with the stand-alone NIC. One of the criteria should be whether the NIC in the pool is running at the same or a greater speed than the stand-alone NIC. Otherwise any TLB team created at 1024 may have less aggregate throughput then the one NIC team. Those of skill in the art will recognize that this is not necessary, but it saves the application 600 from allocating the inappropriate resource and then having to reclaim it based on some other rule later. It would also avoid the possibility of an oscillation between allocating and recapturing the inappropriate NIC until an appropriate one becomes available in the pool. If an appropriate NIC is not currently available from the pool, application 600 will create the TLB team when one becomes available at 1024. Processing then continues at starts over at 904, FIG. 8A.

Those of skill in the art will recognize an additional benefit to an embodiment of system 100 that includes support for VLANs such as that illustrated in FIG. 2B. The use of VLAN switching permit's the interface resources (e.g. NICs or NIC ports) in the pool to be coupled to the VLAN switch 250 but without being coupled to any VLAN segment of the network. Whenever application 600 either assigns to or recaptures resources from a team, the application 600 can instruct the teaming driver to either bind to or release from the team of drivers the driver associated with that resource. In addition, the resource must be either coupled to or decoupled from the VLANs to which that team is coupled. The teaming driver for the team to which the resource was added or from which the resource was recaptured sends configuration information down the link for that resource to the switch 250. The appropriate configuration information will thereby instruct the switch to either connect to or disconnect the link from all of the VLANs to which the team is assigned.

Thus, in FIG. 2B the link L8 which is currently assigned to VLANs A 220a and C 220c can be recaptured to the pool by unbinding its driver from under the intermediate teaming driver 310 and by instructing the VLAN switch to internally decouple the switch port to which the resource's link is connected from all switch ports coupled to VLAN segments. Link 8 (and its associated network resource) can be added to the TLB team that already includes links L3, L4, L5 by commanding the teaming driver for that team to bind the resource's driver with the drivers of all other current team members, and to send configuration information over link 8 to switch 250 to couple the switch port to which link L8 is coupled to the switch port(s) coupled to all devices of VLAN B 220b.

Thus, a user can initially set up configuration policies through the rules by which to govern dynamic allocation and configuration of system network interface resources based on the current usage and status of the resources. Load balancing teams can be managed to receive additional resources from a pool when saturated and to give up underutilized resources to the pool. Their load balancing algorithms can be detected as non-optimal and changed to a more optimal one. Even mistakes in creating load balancing teams can be corrected, such as when slower team members are dragging down a faster resource, or when a team member is not operational and thus not providing load balancing at all. NFT teams can be turned into LB teams when saturated by adding resources from the pool. NFT teams down to one operational member and thus providing no fault tolerance can be can be brought back up to providing fault tolerance by replacing a failed member with an operational one from the pool. Failed resources are identified and recaptured to the pool for repair or replacement. Moreover, by pooling resources, the need for redundancy can be shared over several teams, reducing the number of idle resources. It is easy to alter policy as needed by extending the rules as needed or simply reconfiguring the rules already available.

What is claimed is:

1. A method of dynamically allocating and configuring network resources of a computer system, said method comprising:
initially allocating the network resources among one or more teams and a pool;
establishing one or more usage policies for at least one of the one or more teams;
continuously monitoring usage of the network resources to identify actionable resource usage conditions; and
reconfiguring the network resources in accordance with the one or more usage policies in response to the actionable resource usage conditions.

2. The method of claim 1 further comprising preventing the computer system from using the pooled resources for purposes other than said pool.

3. The method of claim 1 wherein said reconfiguring the network resources further comprises adding network resources from the pool to at least one of the one or more teams in response to at least one of the identified actionable resource usage conditions.

4. The method of claim 1 wherein said reconfiguring the network resources further comprises recapturing network resources from at least one of the one or more teams to the pool in response to at least one of the identified actionable resource usage conditions.

5. The method of claim 4 wherein said recapturing network resources further comprises marking the recaptured resources as needing attention if they are not in a functional state.

6. The method of claim 5 wherein said recapturing network resources further comprises generating an alarm in response to resources needing attention being present in the pool.

7. The method of claim 6 wherein said recapturing network resources further comprises repairing or replacing resources needing attention and marking them available.

8. The method of claim 3 wherein the least one of the identified actionable resource usage conditions is that aggregated usage for the at least one team has reached a predetermined threshold for a predetermined period of time and the at least one team is a transmit load balancing (TLB) team.

9. The method of claim 1 wherein said reconfiguring the network resources further comprises changing the at least one team from a network fault tolerant (NFT) team to a TLB team when at least one of the identified actionable resource usage conditions is that aggregated usage for the at least one team has reached a predetermined threshold for a predetermined period of time and the at least one team is a TLB team.

10. The method of claim 4 wherein the at least one of the identified actionable resource usage conditions is that the at least one team is a NFT team having more than one standby network resource.

11. The method of claim 4 wherein the at least one of the identified actionable resource usage conditions is that the at least one team is a LB team having a team aggregate throughput less than a predetermined threshold for a predetermined period.

12. The method of claim 4 wherein the at least one of the identified actionable resource usage conditions is that the at least one team is a TLB team having a network resource over which data is not being balanced and is the recaptured network resource.

13. The method of claim 3 wherein:
the at least one team is a single network resource team;
the least one of the identified actionable resource usage conditions is that usage for the single network resource has reached a predetermined threshold for a predetermined period of time and the at least one team is a TLB team; and
said adding further comprises converting the at least one team from a single network resource team to a TLB team including the network resource allocated from the pool.

14. The method of claim 3 wherein:
the at least one team is a single network resource team;
the least one of the identified actionable resource usage conditions is that the single network resource has failed; and
said adding further comprises replacing the failed network resource with the network resource allocated from the pool.

15. The method of claim 3 wherein the least one of the identified actionable resource usage conditions is that the at least one team has less than two functional network resources; and said adding further comprises replacing the failed network resource with the network resource from the pool.

16. The method of claim 5 wherein the least one of the identified actionable resource usage conditions is that the at least one team has less than two functional network resources; and nonfunctional network resources of the at least one team are the network resources recaptured to the pool.

17. The method of claim 1 wherein said reconfiguring the network resources further comprises increasing transmit buffer resources for a network resource of at least one team when at least one of the identified actionable resource usage conditions is that the network resource is experiencing transmit underruns.

18. The method of claim 1 wherein said reconfiguring the network resources further comprises increasing receive buffer resources for a network resource of at least one team when at least one of the identified actionable resource usage conditions is that the network resource is experiencing receive underruns.

19. The method of claim 1 wherein said reconfiguring the network resources further comprises changing a LB algorithm for a LB team to a balance by IP address algorithm when at least one of the identified actionable resource usage conditions is that one NIC resource of the LB team is handling a majority of traffic transmitted by the LB team, most traffic transmitted by the team is destined for one MAC address, and traffic transmitted by the LB team is destined for multiple IP addresses.

20. The method of claim 4 wherein:
the at least one team is a TLB team;
at least one of the identified actionable resource usage conditions is that at least two members of the TLB team have different throughputs and two or more of the team members are running at a highest throughput level of the TLB team; and
said recapturing further comprises returning all team members running at a throughput less the than highest throughput for the team to the pool.

21. The method of claim 3 wherein:
the at least one team is a TLB team;
at least one of the identified actionable resource usage conditions is that at least two members of the TLB team have different throughputs and only one of the team members is running at a highest throughput level of the TLB team;
said reconfiguring further comprises changing the TLB team to a NFT team using the one member running at the highest throughput for the team as a primary and one of the other members as a standby; and
said recapturing further comprises returning the remaining members of the TLB team to the pool.

22. The method of claim 3 wherein:
the at least one team is a TLB team;
at least one of the identified actionable resource usage conditions is that at all members of the TLB team have the same throughputs and more than one member of the TLB team is receiving data having the TLB team's MAC address; and
said reconfiguring further comprises changing the team from a TLB team to a SLB team.

23. The method of claim 3 wherein:
the at least one team is a NET team;
at least one of the identified actionable resource usage conditions is that at all members of the TLB team have the same throughputs; and
said reconfiguring further comprises changing the team from a NFT team to a TLB team.

24. The method of claim 4 wherein the at least one of the identified actionable resource usage conditions is that the pool is empty of functional network resources and said recapturing further comprises placing back in the pool a network resource form from one of the one more teams that is least adversely affected by said recapturing.

25. The method of claim 3 wherein:
the computer system is coupled to a network through a programmable switch; and
said reconfiguring further comprises programming the switch to couple the network resource to one or more network segments to which the at least one team is also coupled.

26. The method of claim 4 wherein:
the computer system is coupled to a network through a programmable switch; and
said recapturing further comprises programming the switch to decouple the network resource from one or more network segments to which the at least one team is also coupled.

27. The method of claim 1 wherein said initially allocating further comprises receiving inputs describing the initial allocation through a graphical user interface.

28. The method of claim 1 wherein said establishing one or more usage policies further comprises receiving inputs enabling one or more rules through a graphical user interface.

29. The method of claim 1 wherein at least one of the one or more established policies includes recapturing a network resource to the pool from a team of network resources when the team is detected as comprising underutilized network resources given the current usage of the team.

30. The method of claim 1 wherein at least one of the one or more established policies includes recapturing a network resource to the pool from a fault tolerance team when the team is detected as having an extra allocated network resource that is operable to provide fault tolerance.

31. The method of claim 1 wherein at least one of the one or more established policies includes recapturing a network resource to the pool from a NFT team when the team is detected as having more than one allocated network resource that is operable to provide fault tolerance.

32. The method of claim 1 wherein at least one of the one or more established policies includes recapturing a network resource to the pool from a load balancing team of network resources when usage of that network resource is determined to fall below a predetermined minimum level of usage for a predetermined duration of time.

33. The method of claim 1 wherein at least one of the one or more established policies includes recapturing a network resource to the pool from a load balancing team of network resources when usage of the team is determined to be not balanced across that network resource.

34. The method of claim I wherein at least one of the one or more established policies includes recapturing a network resource to the pool from a load balancing team of network resources when throughput of that network resource is substantially less than that of the other network resources of the load balancing team.

35. The method of claim 1 wherein at least one of the one or more established policies includes changing from a first algorithm by which traffic load is balanced over a load balancing team of network resources to a second load balancing algorithm when the second algorithm provides more optimal load balancing given current usage of the team.

36. The method of claim 1 wherein at least one of the one or more established policies includes changing the configuration of a team of resources from a fault tolerant team to a load balancing team when all network resources operate at a throughput that is substantially the same.

37. The method of claim 1 wherein at least one of the one or more established policies includes changing the configuration of a team of resources from a load balancing team to a fault tolerant team when at least one of the network resources operates at a disparate throughput.

38. The method of claim 1 wherein at least one of the one or more established policies includes adding at least one network resource from the pool to a load balancing team when the resources of the load balancing team have reached predetermined level of usage for a predetermined duration of time.

39. The method of claim 1 wherein at least one of the one or more established policies includes reprovisioning a network resource when it becomes low on communication resources.

40. The method of claim 1 wherein at least one of the one or more established policies includes adding at least one network resource from the pool to a team comprising a single network resource when the single network resource fails.

41. A computer system comprising:
a plurality of network resources each having a link for coupling processing resources of the computer system to at least one network device, each of the processing resources further having a driver associated therewith;
an intermediate teaming driver configured to run in conjunction with the computer system's operating system, each instance of the driver operable to bind the drivers of two or more of the plurality of resources into a team;
a resource allocation application configured to run in conjunction with the operating system, the application operable to monitor the usage and status of network resources individually and the teams, to identify one or more actionable resource usage conditions based on usage policies defined by a set of extensible rules and to reconfigure the teams in accordance with the actionable resource usage conditions.

42. The computer system of claim 41 wherein the resource allocation application is configured to maintain a pool of resources from which unallocated resources are allocated to existing teams in accordance with the identified one or more actionable resource usage conditions.

43. The computer system of claim 42 wherein the resource allocation application is configured to recapture underutilized and failed network resources from the teams to the pool.

44. The computer system of claim 43 wherein the resource allocation application is configured to add a resource from the pool to a team by programming the at least one network device to couple the link associated with the added resource to network segments to which the team has been assigned.

45. The computer system of claim 44 wherein the resource allocation application is configured to recapture a resource from a team back to the pool by programming the at least one network device to decouple the link associated with the added resource from network segments to which the team has been assigned.

46. The computer system of claim 41 further comprising a configuration application, the configuration accessible through a graphical user interface by which the set of extensible rules are selected and parameterized.

47. A method of dynamically allocating and configuring network resources of a computer system, said method comprising:
initially allocating the network resources among one or more teams and a pool;
establishing one or more usage policies for at least one of the one or more teams;
continuously monitoring usage of the network resources to identify actionable resource usage conditions; and
reconfiguring the network resources in accordance with the one or more usage policies in response to the actionable resource usage conditions, said reconfiguring the network resources further comprising adding and recapturing network resources from the pool to at least one of the one or more teams in response to at least one of the identified actionable resource usage conditions.

48. The method of claim 47 wherein said establishing one or more usage policies further comprises receiving inputs enabling one or more rules through a graphical user interface.

49. A method of dynamically allocating and configuring network resources of a computer system, said method comprising:
initially allocating the network resources among one or more teams and a pool;
establishing one or more usage policies for at least one of the one or more teams, the usage policies established through selection of one or more rules through a graphical user interface;
continuously monitoring usage of the network resources to identify actionable resource usage conditions; and
reconfiguring the network resources in accordance with the one or more usage policies in response to the actionable resource usage conditions.

50. A computer system comprising a plurality of network resources, said computer system comprising:
means for initially allocating the network resources among one or more teams and a pool;
means for establishing one or more usage policies for at least one of the one or more teams;
means for continuously monitoring usage of the network resources to identify actionable resource usage conditions; and
means for reconfiguring the network resources in accordance with the one or more usage policies in response to the actionable resource usage conditions.

51. The computer system of claim 50 wherein said means for reconfiguring the network resources further comprises means for adding network resources from the pool to at least one of the one or more teams in response to at least one of the identified actionable resource usage conditions.

52. The computer system of claim 50 wherein said means for reconfiguring the network resources further comprises means for recapturing network resources from at least one of the one or more teams to the pool in response to at least one of the identified actionable resource usage conditions.

53. The computer system of claim 50 wherein said means for initially allocating further comprises means for receiving inputs describing the initial allocation through a graphical user interface.

54. The computer system of claim 50 wherein said means for establishing one or more usage policies further comprises means for receiving inputs enabling one or more rules through a graphical user interface.

55. The computer system of claim 51 wherein:
the computer system is coupled to a network through a programmable switch; and
said means for reconfiguring further comprises means for programming the switch to couple the network resource to one or more network segments to which the at least one team is also coupled.

56. The computer system of claim 52 wherein:
the computer system is coupled to a network through a programmable switch; and
said means for recapturing further comprises means for programming the switch to decouple the network resource from one or more network segments to which the at least one team is also coupled.
